(19) United States
(12) Patent Application Publication
(10) Pub. No.: US 2013/0144605 A1
(43) Pub. Date: Jun. 6, 2013

(54) Text Mining Analysis and Output System

(71) Applicant: MEHRMAN LAW OFFICE, PC, Atlanta, GA (US)

(72) Inventors: Barry A. Brager, Symrna, GA (US); Jeffrey M. Davidson, Atlanta, GA (US); Jeffrey S. Aaronson, Cherry Hill, NJ (US); Craig R. Meyer, Wynnewood, PA (US)

(73) Assignee: MEHRMAN LAW OFFICE, PC, Atlanta, GA (US)

(21) Appl. No.: 13/707,590

(22) Filed: Dec. 6, 2012

Related U.S. Application Data
(60) Provisional application No. 61/567,359, filed on Dec. 6, 2011.

(51) Int. Cl. G06F 17/28

(52) U.S. Cl. CPC G06F 17/28
USPC 704/9

(57) ABSTRACT

A natural language authoring system that organizes technical, financial, legal and market information into Point of View specific analytical, visual and narrative decision-support content. The expert system transforms a user's point of view into a tailored narrative and/or visualization report. Expert rules embed interactive advertising, such as affiliate URL links, into analytical, visual and narrative and statistical content. The rules may be modified by one or more users, thereby capturing knowledge as the rules are utilized by users of the system.

### REFERENCE TO RELATED APPLICATION

This application claims priority to commonly owned U.S. Provisional Patent Application Ser. No. 61/567,359 entitled “Expert Research Solution System” filed Dec. 6, 2011, which is incorporated by reference.

### TECHNICAL FIELD

The present invention relates to automated natural language authoring systems and, more particularly, to a point of view specific data extraction and multi-media natural language output generation system.

### BACKGROUND

An extensive body of knowledge has evolved describing sophisticated processes for discovering valid, novel, potentially useful and ultimately understandable business knowledge by conducting analysis of literature databases. Commercial uses in discovering, formulating and quantifying aspects of strategic competitive advantage have been documented extensively. Patent analysis, product analysis, legal action analysis, investment analysis, competitive market analysis, customer behavior analysis, social network analysis and demographic analysis are typical examples where database analyses can be effectively utilized. Although some applications of database analysis (e.g., patent, literature database analysis) have been debated regarding risk for error or usefulness, it has nonetheless become commercially accepted as a unique and effective source of competitive technical and business intelligence. In some cases, strategic knowledge has been gathered from structured database records (e.g., patents, literature) by cross-correlating common fields. e.g., bibliometric fields. Bibliometric field analysis can in fact be performed on many types of literature. In particular, this type of analysis has been effectively used to quantify relationships that describe authors, sponsors, citations, relevant dates, descriptors, identification codes and other desired data items.

Strategic business knowledge may also be located in literature data using linguistic text analysis. For example, a number of text-intensive fields may be found in patents and literature, which may be written according to various rules and appearing in varying lengths—sometimes in the hundreds or thousands of pages. Technologies such as natural-language processing (NLP) have been shown to reduce the burden of reading all parts of a patent or literature document, yet still capture meaningful concepts. Text analysis also may be improved by using taxonomies or concept hierarchies which can reduce data complexity and which can be analyzed further to convey information about trends and transitions for knowledge discovery.

Beyond bibliometric and text analytical methods, visualization tools have been used to display and improve database (e.g., patent, literature) analysis. Visualizations are typically prepared in stand-alone systems or can be generated online as part of toolsets integrated with proprietary databases. Visualizations that concisely correlate a multiple of meaningful metrics (e.g., 5-15 at a time) can be extremely helpful to expert analysts and typical end-users as “dashboards,” “one-pagers,” or “focused landscape maps.”

Visualizations alone, however, are incomplete for authors or authoring entities to convey actionable meaning to end-users. Further analytical interpretations must often be added to provide suggestions, recommendations and references to end-users to generate actionable deliverables once meaning has been drawn from the data and conclusions have been reached.

A variety of techniques have been utilized to author analyses and/or opinions that follow a validated line of reasoning or rules. For example, econometric approaches have been developed to assess the importance of technology in terms of intellectual property value or R&D importance. Bibliometric approaches have been used to measure citation characteristics of cycle time, science strength or speed of knowledge appropriation to identify high-impact patents. “Tech Mining” text-and-data-extraction approaches have been developed to reveal partnering, entry and exit trends using co-occurrence, correlation (cross- and auto-) and factor matrices. Licensing “rules of thumb” have been devised by expert practitioners to help formulate strategies for value-based action or inaction. Management style approaches that integrate visual and text analysis have also been used to inform investment and policy decisions. Marketing decision-making relies heavily on rules to drive predictive analysis, such as store visits, basket composition, or purchase intent. Many other rules no doubt exist that combine any or all approaches to increase understanding of strengths and weaknesses—among other attributes—to enable strategic exploitation of business insights found within one or more databases.

Currently available systems have a major drawback, however, in that they have been developed on an ad-hoc basis and therefore vary greatly in approach, design, output and quality. As a result, highly compensated experts are typically required to custom-design the research, interpret the data, format the output, draw conclusions and make recommendations for the end-user. As the types and sources of online databases have proliferated, culling and interpreting valid and commercially important source data has become increasingly important. Bibliometric and other text and data extraction and analysis systems have correspondingly become increasingly data intensive, sophisticated and integral to competitive business models. As the universe of available source data grows, so grows the potential cost and complexity of systems to extract, analyze, make sense of and take action on the data.

There is, therefore, a continuing need for improved bibliometric and other text and data extraction and analysis systems and, more particularly, a need for more effective, timely and efficient business intelligence systems to address the commercial analytical needs of competitive markets.

### SUMMARY

The invention may be embodied in a text mining analysis and output (TMAO) system that applies rules and generates customized outputs tailored to the point of view of particular users. The system may use one or more of predefined input templates, input data solicitation devices such as intelligent questionnaires, taxonomies, generic textual compositions, and generic numerical presentation formats to compose output formats combining natural language presentations, extracted text, extracted data, multi-media outputs, and advertising data such as recommendations, referrals and affiliate links. The rules, source data, output data, and presentation formats are exposed for user feedback and may be used to modify and improve the analysis system. All or part of the same data may also be exposed for feedback to a community of users, which may include novices, casual users, experienced parties and industry experts in the relevant area of technology. This community feedback may also be used to modify and improve the analysis system. The system further includes affiliate and community reward components to incentivize, review, evaluate, rate, prioritize and incorporate feedback to continually improve the system.

This type of system effectively automates a meaningful portion of the data gathering, processing and presentation logic to significantly increase the amount of source data that can be cost-effectively gathered, evaluated, formatted and reflected in analytical outputs. This results in greater consistency in the analyses, higher quality in the presentation, and greater confidence in the results, while reducing costs and removing reliance on experts to implement ad hoc custom analyses.

The resulting system allows non-expert authoring entities to implement an automated data analysis approach capable of producing superior results to standalone graphic visualization or an ad-hoc analysis based a single expert's documented line of reasoning. This is because it is often very difficult for a non-expert user to replicate the factors that led the expert to the reasoning they originally validated, which is often explained with overly vague generalizations or steeped in opaque jargon. In other cases, interpretation of visualization can be very subjective, and different viewers could perceive different implications, especially in visualizations where dimensionality is reduced and the underlying data is unavailable.

Unlike conventional approaches, the present invention uses computer-based systems to solve problems by applying rules that, in an exemplary embodiment, are designed to imitate in some respects the data gathering and reasoning processes of one or more domain experts. Relevant data sources (project data) are identified and rules are gathered and applied to the project data. The project data, import filters, rule sets, output data and presentation formats can be modified and supplemented through user and community feedback to iteratively improve all aspects of the system. A relevant rule set is thereby collected and improved through feedback received over time, to ultimately contain and update what is necessary to identify, extract, process and present specific data to solve a problem, make a decision or communicate a message. In an exemplary embodiment, the TMAO system contains the procedures for processing data and addressing a wide range of needs through a largely computerized system providing user interfaces templates that are easy for non-experts to use and understand.

The data analysis procedures may apply, e.g., forward-chaining or data-driven reasoning which starts with processing of data to reach an ultimate conclusion, or backward-chaining or goal-driven reasoning which starts with a desired conclusion. Other exemplary types of reasoning include fuzzy logic, neural networks, and Bayesian logic. A template-based user interface enables expert and non-expert users alike to identify a dataset to be analyzed, specify an objective for the analysis, modify preferences for the style and content of the output, and ultimately receive the published output. While input templates are not new in information science, the present invention provides a commercial package that minimizes software programming requirements to enable most of the development effort to be managed by non-programmers who may be the domain experts themselves, or who may be collaborators with domain experts in a more cost effective manner than the conventional approach of simply turning the entire project over the expert (or the programmer), waiting for the result and hoping for the best.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE FIGURES

The numerous advantages of the invention may be better understood with reference to the accompanying figures in which:

FIG. 1 is a block diagram illustrating an operating environment for a text mining, analysis and output system.

FIG. 2 is a process diagram illustrating operation of the text mining, analysis and output system.

FIG. 3 is a user interface diagram illustrating an example output display generated by the text mining, analysis and output system.

FIG. 4 is a data organization diagram of a taxonomy rule set using in the text mining, analysis and output system.

FIG. 5 is a system architecture diagram for the text mining, analysis and output system.

FIG. 6 is a provisioning methodology diagram for the text mining, analysis and output system.

FIG. 7 is an operating methodology diagram for the text mining, analysis and output system.

FIG. 8 is a logic flow diagram illustrating a business model utilizing the text mining, analysis and output system.

FIG. 9 is a logic flow diagram for configuring the text mining, analysis and output system.

FIG. 10 is a logic flow diagram for provisioning the text mining, analysis and output system.

FIG. 11 is a logic flow diagram for running the text mining, analysis and output system.

FIG. 12 is a logic flow diagram for obtaining user feedback in the text mining, analysis and output system.

FIG. 13 is a logic flow diagram for obtaining community feedback in the text mining, analysis and output system.

FIG. 14 is a graphical user interface display for Point of View information in the text mining, analysis and output system.

FIG. 15 is a graphical user interface display for rule information in the text mining, analysis and output system.

### DETAILED DESCRIPTION OF ILLUSTRATIVE EMBODIMENTS

The invention may be embodied in a computerized or computer-assisted business model and an associated system known as the text mining analysis and output (TMAO) system. This system organizes multiple types of information (e.g., technical, financial, legal, market and advertising information) into multiple types of outputs (e.g., analytical, visual and narrative decision-support content)—which may be tailored to the point of view of one or more users. The system also contains rules that are updatable for future use based on feedback from one or more users. The TMAO system is designed to collect, prepare, organize, prioritize, tailor, visualize and publish analyses of, e.g., technology literature (e.g., patents, scientific papers, standards); legal literature (e.g., litigation history, patent prosecution history); business literature (e.g., press releases, financial filings, market research reports, trade journal articles, news); marketing information (e.g., social network activity, purchasing habits, web browsing behavior, shopper insights); geospatial data collections (e.g., terrain mappings, LiDAR tiles) and advertising opportunities (e.g., offer to buy a full-text document, offer to contact an expert, offer to click a paid ad link, offer to upgrade the quality of results) in order to inform a user by emulating the logic of the most relevant experts in the field. The results are combined into meaningful, interactive visual and narrative explanations.

In some cases, the point of view discernable from the output of the TMAO system will vary depending on the point of view of the user(s) (also referred to as the authoring entitie(s), and system administrator(s), and those who may review and take action on the TMAO output, which may be human, computerized, multiples or combinations of these types of entities). As examples, the same source data run through the TMAO system by, e.g., a user who is a defendant in litigation and who is seeking to understand licensing options, may be interpreted differently than by e.g., a user who is vice president of research & development and who is looking to invest appropriately for a five-year strategic plan. The system's determination of the point of view for a particular project may be facilitated by an “intelligent questionnaire” or other input process by which an authoring entity could express preferences on a number of personalizing factors, such as business needs, technology preferences, legal situations, timeline or urgency, financial objectives, desired outcomes or outputs, undesirable outcomes or outputs, required deliverables, optional deliverables, preferred data sources, preferred search criteria, preferred categorization criteria, metrics for success, identity of key stakeholders, or other criteria deemed important and collected by the system.

There may be a number of different points of view to be considered in order to create outputs from the TMAO system. A point of view may be determined for a single user or for a class of users, e.g., venture investors. An example list of user classes, representing potentially different points of view, may include corporate R&D manager, corporate development manager, corporate IP counsel, external IP counsel, defendant, plaintiff, judge, institutional investor, venture investor, private equity investor, university technology transfer and commercialization manager, federal laboratory technology transfer and commercialization manager, research institution technology transfer and commercialization manager, patent examiner, university professor, student, professional researcher, scientist, economic development officer, governing authority manager, non-governmental organization manager, journalist, market researcher, market analyst, social media analyst or other potential user interested in obtaining useful outputs based on text and data identification, extraction, and analysis.

The envisioned uses of the TMAO system include, for example, technology monitoring, competitive landscaping, technology forecasting, technology road mapping, innovation partner identification, white space analysis, product clearance, valuation, portfolio assessment, strategic planning, economic development, investment management, lead generation, predictive marketing, market research, policy decision-making, employee recruiting, route planning, social network analysis, fraud analysis, credit worthiness and many other opportunities presently existing and to be developed in the future.

Importantly, the TMAO system may be provisioned to perform a myriad of uses beyond these specific examples because the source data, point of view, and desired outputs may be designed to operate on virtually any type of data of interest for virtually any type of user including human, collaborative, community, and computerized users. Moreover, the amount and types of electronic information the system is capable of analyzing is similarly unlimited (i.e., conceptually limited only by the extent of motivation and skill the universe of users possess in accessing and incorporating the data into the TMAO system). The TMAO system is therefore expected to enable individuals and organizations to respond to global competitive forces more quickly, efficiently, and deeply with an expert level perspective tailored to the point of view of one or more interested users.

The TMAO system therefore presents an improved approach for knowledge discovery in databases. Typical outputs may include tailored listings of a wide range of information culled from the source data, such as authors or inventors, citations or references, institutions or organizational affiliations, geographic locations, publishing sources, dates or years, identification codes, tags or categories, products and markets, and so forth. For the TMAO system to best understand and process the input data, some pre-processing may be required in order to condition the data before any rules are applied. The result of this pre-processing will ordinarily be one or more textual and/or numerical values.

To provide one specific example, the TMAO system may be operative for converting pre-processed data into XML, specifying a user point of view with which to view the data, processing and preparing the data for rules-based analysis, extracting and correlating pertinent information according to the system rules and storing them in a memory buffer. The TMAO system then inserts the extracted and stored information into, e.g., database records, electronic documents or interactive templates resulting in the presentation or output of narratively drafted natural language statements, questions, visualizations, data presentations, numerical presentations, multi-media content, portals, hyperlinks or data extractions regarding important topics.

The content of the system-generated output may be interactively linked by hyperlinks, portals or other active components to the underlying data stored elsewhere in whole or in part. In fact, the text of specific narrative topics and the graphics within specific visualizations may be linked to specific groups of records or metadata about those records. Each group of records may contain the exact source data originally pre-processed for those same records, or alternatively that source data may be converted into a more standard form, such as XML according to the RSS 2.0 or Atom 1.0 specifications. Advantageously, groups of records accessible as e.g., RSS, may be viewed, manipulated and shared by a user in context with or in addition to a user's interaction with the system-generated output.

Advertising may be an additional feature of the output. For example, a narrative report output might provide a written suggestion on (preferably trusted and/or validated) experts to contact regarding a particular topic, with some experts selected from a list of advertisers paying for the right to be referred. In another example, a graphical display of analytical trends may be accompanied by a “how-to” video provided by a sponsor, with that video linking to the sponsor's website in exchange for the sponsor paying a click-through fee. In yet another example, the text of underlying records in an analysis—accessible from hyperlinked text in a narrative or from graphical bars in a bar chart—may further hyperlink to full text documents for sale, with the document seller providing a fee for each document purchase referral opportunity. In still another example, narrative suggestive text could be generated by the TMAO system, then further paired with other text, visuals or content, and that suggestive text could connect a user to a registration opportunity with another product or service provider. In this example, the product or service provider would pay a fee or issue credit or provide some other form of beneficial compensation (e.g., co-branding, revenue sharing, bounty sharing, etc.) to the facilitator of the TMAO system. In these example advertising-related embodiments, it is an object of the system architecture of the invention to enable such advertising when preparing data, organizing data, considering a user(s) point of view, formatting data and providing a learning system.

As an output is explored by a user or community member, they may begin to form opinions related to the e.g., relevance, probability, precision or recall associated with the e.g., point of view, narrative, visualizations, underlying data or advertising opportunities described in an output of the TMAO system. In addition, an output generated by the TMAO system may display a confidence interval, score, graphic or predictive measure that could explain to a user the certainty or relevance associated with a particular narrative, visual or explanatory item of content. As users form their own opinions of the presentation, and are then further informed by additional information such as confidence, they will be able to apply their own expertise to improve the accuracy, confidence, relevance or other success indicator when next requesting the generation of an output from the same underlying source data. It is also an object of the TMAO system to encourage users to adjust system rules by drafting, amending or suggesting amendments to rules using, e.g., conditional if/then logic. It is further an object of the TMAO system to enable the exposing of, review of, modification of, commenting on and incentivizing participation in, system rules and rule sets by one or more users of the TMAO system.

The ability for a user or groups of users within a user community to see and improve rules within the TMAO rules-based system is advantageous. The rules of the TMAO system may be amended in a number of ways, for example by a multi-step method of user feedback (unmoderated forum, moderated forum, a wiki, email), which would lead to moderator approval (manual approval, ranked approval, scored approval) which would then lead to (automated, semi-automated, or manual) system administrator modifications to system rules. Users may also contribute to rules as part of a challenge method (e.g., game, contest, besting a benchmark goal) whereby a user is exposed to some or all parts of a rule, adjusts at least some part of the rule, runs the rule on system data and compares a resultant confidence interval, score, etc. vs. a previous result, benchmark result or other criterion. At that point an algorithm, other user or group of other users can determine if the new result indicates that the rule should be changed. If so, then the system or a system administrator could flag the rule for change or automatically update the rule. Changed rules could be time stamped, and those users obtaining one or more successful changes may receive recognition for their contribution to the TMAO system. Such contributions may be incentivized in the form of e.g., reputational enhancement, prizes, rewards, credit, cash or future benefit.

Of particular use to the TMAO system are rule-based “tags” or “categories.” When structured into a hierarchy of two or more levels (e.g., parent-child, tree-leaf or spoke-hub), such sets of tags or categories may be known as a taxonomy. It is often advantageous to develop, acquire or assign categorical metadata to records, especially when those records are from different sources. A strength of categorization is that it can apply a homogenous organizing logic with which to analyze categorized records. A significant challenge to categorization is that different technical domains and different points of view may require different organizational approaches. In addition, experts may differ on how to organize a single domain. The TMAO system has the capability to address these challenges.

In the TMAO system, category assignments may be applied using rules. These rules may be pre-programmed by an expert or system administrator. In another embodiment, categories may be adjusted by another user or user group within a community according to the methods described above. The net effect would be to encourage one or more users—or groups of users—to establish, maintain and upgrade rules related to categorization and to originate, modify and continuously improve categorization of the data required by the TMAO system. Those skilled in the art will appreciate that categorization at times may be an input of the system, at other times may be an output of the system, and still at other times may be a parameter of the system whereby an input is transformed into an output.

As regards system outputs, it is important to point out that the narrative outputs of the TMAO system will optimally be written as if by a human, and even more optimally, written as if telling a story. This requires a use of lexical and grammatical structure and structured incorporation of ideas, as well as vocabularies, semantics, and relationships that are consistent with human output. The TMAO system is therefore configured to create narrative output in a desired natural language associated with defined grammar rules. The TMAO system uses the point of view, optional taxonomies, lexical rules, grammar rules, and system rules to vary vocabulary, phrasing and sentence structure to create narrative outputs. Many existing resources may be further utilized in the effort, such as dictionaries, encyclopedia, thesauri, databases and websites, look up tables and artificial intelligence.

In many circumstances, story design (to improve a user's understanding of a system output) is among the most significant challenges of the TMAO system. To address this need, the TMAO system may create outputs in briefer textual structures, e.g., lists, phrases, headlines, captions, and in more robust textual structures, e.g., sentences, paragraphs, summary-detail and question-and-answer structures. For example, one robust structure that may be used to assemble stories may be based on the premises underlying the Pyramid Principle, as advocated by author Barbara Minto. In short, the Pyramid Principle advocates rules by which ideas at any level in a structure of organized concepts must always be summaries of the concepts grouped below them. In the TMAO system, concepts may be organized via a data categorization system that utilizes a hierarchical data tagging and categorization structure, which creates and nests concepts into entities, taxonomies, and the like. The data categorization system can also contain metadata about concepts and categories, such as hierarchical position in a taxonomy. This information may be used to determine which categories of ideas should be grouped above or below another category of ideas when e.g., narrative text or sequenced images are to be output by the TMAO system. Ideas in each grouping may ordinarily be the same kind of idea (e.g., all fruits or all items of furniture).

The data categorization system can also capture entity types, e.g., person, place or thing, in a taxonomy. This information can be further correlated with metadata about, e.g., time-based, size-based, industry-based or semantic relationships. This correlated data may be accessed by system rules when preparing narrative text to ensure that ideas are grouped consistently. Ideas in each grouping may therefore be logically (e.g., deductively, chronologically, structurally, comparatively) ordered. The ordering of grouped ideas may be created using system rules that consider a combination of data categorization, user point of view and analysis of pre-processed data in order to first select the grouping logic and then to apply the logic to a group in order to effectively communicate the story requested by one or more users as a report or presentation. The system rules above can be implemented into the rules of the TMAO system in order to produce narrative text that is more likely to appear as a story written by a human.

Another way to organize the output of the TMAO system into a story is to organize narrative content in a logical, persuasive and/or suggestive form. For example, the story may first present information known to the user to be true or likely to be true, and then progressively advance to information less likely to be known to or not as easily agreed to by the user. This style tends to get more “buy in” from users because they are more likely to agree with the first parts of a narrative, keeping them engaged in its content, message and/or meaning. Following from the Pyramid Principle, the structure of the organizational narrative elements output from the TMAO system, in an exemplary mode of presentation, includes a situation and a complication, optional questions (which may be implied but not necessarily presented to a user) and then main points, comprising answers such as one or more suggestions, resolutions or recommendations.

Generally described, a situation may be a statement about the data or topic that the user is likely to appreciate or engagingly react to because the user already knows it or its wording will pique the user's interest, given the user's point of view. This may be determined by applying system rules comparing user inputs related to the point of view, data collected for analysis, and expert assumptions on how likely certain users are to know or appreciate some type of information presented matter-of-factly. In an exemplary embodiment, the situation is the headline of a slide in an analytical presentation or report generated by the TMAO system.

A complication is typically a “turn” in a story. It describes an alteration to a stable situation, rather than a problem—though an alteration can be a problem. Typical complications can be described and then system rules can be designed to detect them in imported, prepared and/or categorized data. The identification, determination of relevance and/or the narrative description of a complication can be tailored based on the point of view of the user. Typical complications (and rule types that could extract the facts required to narratively draft the complication) may include, e.g., something went wrong (comparative rule), something could go wrong (predictive rule set based on comparative trends), something changed (temporal rule), something could change (predictive rule set based on temporal trends), “here's what you might expect to find” (expectancy rule), “here's someone with a different point of view” (prominence rule), or “in this situation we have limited alternatives” (suggestive rule).

A main point defines the need to be addressed based on the type of complication and in light of the specific situation. To narratively develop a main point in the TMAO system, the main point will be based on first expertly determining an appropriate type of question(s) to ask related to the complication). Key questions related to the complications may include: “what do we do?”; “how can we prevent it?”; “what should we do?”; “how should we react?”; “do we find it?”; “who is right?”; “which one should we take?”; and so forth.

The narrative output describing a main point may or may not include the text of one or more questions. The output will typically include, however, at least one answer. Answers to questions create main points that address complications in light of situations. Answers will be developed by the TMAO system using expert assumptions programmed as system rules, which will be applied to processed data and optionally tailored to the point of view of one or more users. Typical answers may be narratively formatted as, for example, “the next step would be to . . . ”; “one can mitigate this risk by . . . ”; “long term considerations include . . . ”; “given the probability of change, pertinent issues are . . . ”; “the following opportunities have been identified and are recommended . . . ”; “experts to consult regarding implementation may be . . . ”; “there are only a few options worth considering, among them . . . ”

Beyond main points, sub points further narratively discuss the relationship between questions and answers using other facts extracted from the data, optionally tailored to one or more points of view. The number of and narrative construction of sub points may be determined conditionally by system rules as well as the relevance of supporting evidence identifiable in the processed data, categories and the like. The TMAO structure aligns to the type of story told by experts that provide manual analysis, making it an advantageous output for the user by the TMAO system.

The TMAO system exhibits a number of important advantages over conventional approaches including developmental and operational speed: Because analysis is inherently time-consuming, especially if performed on an ad-hoc basis or by cross-functional teams, a TMAO system could accelerate the throughput of technology and business database analysis. The TMAO system also exhibits improved consistency: By standardizing analytical approaches, rules that capture user knowledge can be applied with greater consistency across different datasets and over time than might be expected by analysts with variable skill levels and degrees of rigor, or teams of analysts with changing membership over time or across projects. The system also reduces human resource costs. Rather than allocating the time of typically high-salaried professionals for routine analysis, these resources could instead be freed up to focus on follow-on analyses that use the system outputs in context of an organization's strategy, or on devising advanced strategies and plans built on these analyses. The TMAO system further reduces hidden costs: The hidden burden of publishing reports in an easily digestible narrative, especially for executive-level decision-makers, could be minimized significantly.

Improved quality is one of the most important benefits of the system. Unless analysts and end-users are staying abreast of the practices to mine an expanding topic in the literature—which would be unlikely for resources other than scarce specialized internal/external experts or consulting organizations—they would not easily be able to reliably incorporate the emerging topic knowledge or the knowledge of other experts into their own database discovery approaches.

The system could enhance basic technology research and academic investigation of technology by accelerating discovery of opportunities and highlighting risks related to novelty, defensibility and R&D commercialization success. The TMAO system also facilitates education. It is often difficult or prohibitive to engage industry experts in academic studies. The system could present an ideal resource for codified knowledge that can be applied for discovery by students, faculty and researchers forecasting technological trends or investigating the dynamics of industry structure.

National competitiveness is another important system benefit. The dissemination of results from the system could increase understanding of global strategies in technology development and commercialization—a primary source of competitive strength for regions and nations. This could also present benefits to society at large, as insights could power the decisions of policy-makers and even patent office authorities seeking to balance the rewards and penalties associated with innovation.

Accordingly, it should be appreciated that the TMAO system may construct an output by organizing processed data about business information into narrative text presented in a situation-complication relationship. Data feeds may be dynamically constructed to communicate relationship changes among text or numerical elements within a database. The system outputs may include narrative, image and feed content about the same business information, by applying rules-based analysis to an original data file. The narrative text may be constructed as an output based on a point of view determined for the project, expert rules and further tailored by additional received from inputs from a user. Advertising information, such referrals, recommendations and links to affiliate websites may be contextually embedded within system-generated narrative text or system-generated visualizations.

The TMAO system may also coordinate feedback provided by one or more users, which may include feedback from authorizing entities and community members. A variable may be adjusted in the TMAO system by evaluating user feedback, with primary adjusting criteria based on feedback determined as being optimal based on the result of user participation in one or more games, challenges or community activities. A compensation model may also be implemented in connection with advertising exposures, clicks through to affiliate websites, leads and purchases facilitated by the TMAO system. Many other features and advantages of the system will become apparent to those skilled in the art from the following description of the appended figures.

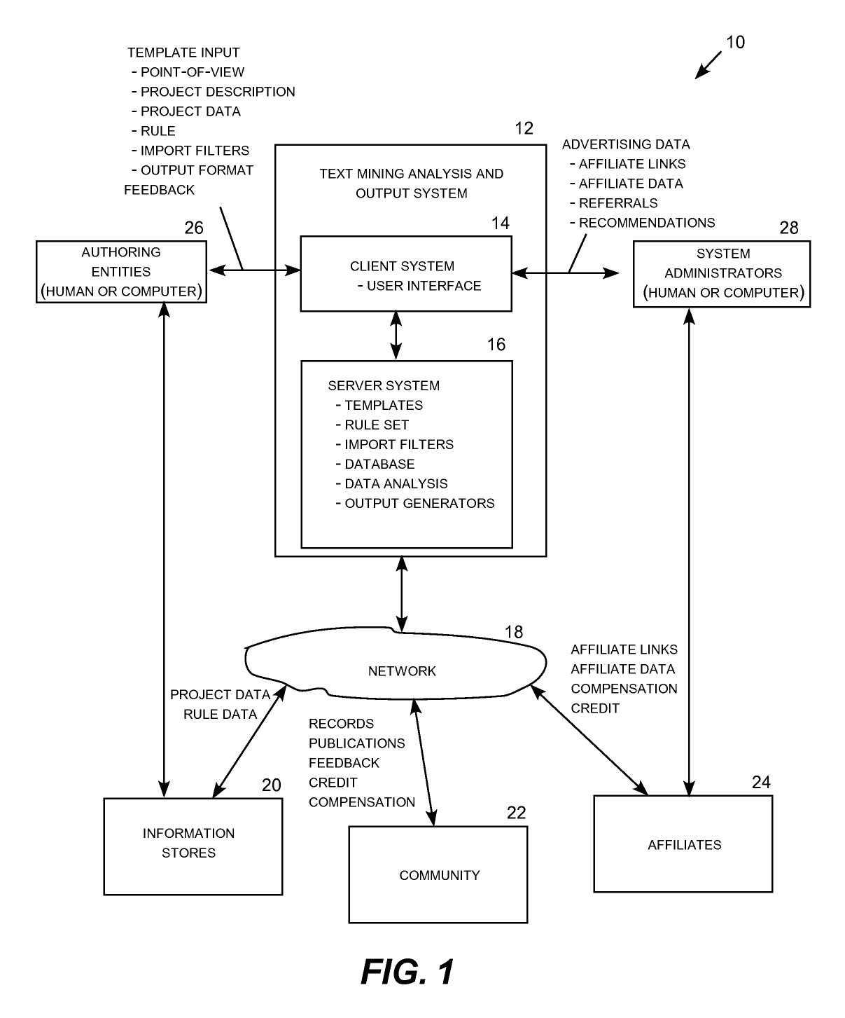

FIG. 1 is a functional block diagram illustrating an operating environment 10 for a text mining, analysis and output (TMAO) system 12. The TMAO system 12 includes a client system 14 that implements a user interface that facilitates user interaction with the system and a server system 16 including a data processor and other electronic elements that implement the functionality of the TMAO system. The server system 14 typically includes a selected combination of features, such as templates for soliciting input from users, import filters that assist in the identification and extraction of target data from information stores, a database for storing project data including the data extracted from the information stores using the import filters, a rule set for processing the data stored in the database to produce desired output, data analysis functionality, and one or more output generators.

Although the client system 14 and server system 16 are shown as individual elements, it will be appreciated that each may be broken into multiple components deployed in separate enclosures and locations and that many instances may be deployed. For example, separate instances to the client system may be implemented by browsers located in different user locations, and separate instances of the server system may be implemented at different licensed user locations.

In general, the features of the server system 16 are designed to be modular and optional so that individual users may select the features that are best suited for particular projects. For example, one user may already have a known rule set for use in a particular project, whereas another may want to develop the rule set as part of their project, and another may want to employ community feedback to help develop and improve their rule set. Similarly, one user may already have a known import filter for use in a particular project, whereas another may want to develop an import filter as part of their project, and another may want to employ community feedback to help develop and improve an import filter. As another example, one user may already know what types of output they are interested in for a particular project, whereas another may want to develop, review, select and refine the output elements and format as part of the project. It will therefore be understood that the server system 16 may, but does not necessarily, include all of the potential features in a single embodiment. Along the same lines, it will also be appreciated that various combinations of features may be selected on a project-by-project basis and that model improvements may be developed, evaluated and incorporated over time as experience grows.

The TMAO system 12 is connected to a network 18, such as the Internet, to provide a range of interconnections. In particular, the network typically connects the TMAO system 12 with a number of information stores 20 where project data and rule data may be identified and extracted for use by the TMAO system. It should be noted that project data may be provided directly by an authoring entity or identified and accessed over the network. The information stores used in different projects may run the gamut from fully structured data, to well defined databases, to search engine results, image archives, video archives, and so forth.

The network also connects the TMAO system 12 with a community 22 that may be engaged in processes of data, rule or output review, feedback and improvement. To implement the community improvement feature, the TMAO system provides the community with project information, such as project data, records and publications, points of view, rule sets and outputs produced by the system to solicit feedback from the community, which is evaluated and may be used to improve the system. The TMAO system may encourage members of the community to provide feedback by providing for incentives, such as recognition, compensation, or credit. For example, reputational scores or rankings may be created by publishing reviews and receiving community feedback on the reviews. Such scores or rankings may then lead to accruing: simple benefits e.g., a badge on a user profile; to broader benefits, e.g., free or discounted access to valuable information such as a full-text journal article; to more direct benefits, e.g., payment of a fee in physical or virtual currency.

The network also connects the TMAO system 12 with affiliates 24 that provide advertising business opportunity for the operator of the system. To enable this opportunity, the system operator forms a number of affiliate relationships with trusted providers of goods and services. The TMAO is configured with affiliate data (e.g., product descriptions, advertisements, etc.) and links to the affiliate websites. The system is also configured to identify when a particular affiliate's goods and services are relevant to a particular project and embeds referrals, recommendations, and links to the affiliate directly into the TMAO output. View exposures, click-through and buy leads may also be monitored with compensation or other credit provided by the affiliate for the advertising and leads provided by the TMAO system.

The client system 14 provides access for a range of potential users, most notably authoring entities 26 and system administrators 28, which may each be human or computerized. The authoring entities 26 are typically authorized to use the TMAO system to run projects, whereas the system administrators 28 are typically authorized to configure, provision and maintain the TMAO. An authoring entity ordinarily accesses the TMAO system through a system of templates designed to intelligently solicit input to define specific projects. Generally, a project definition requires a custom-defined, preselected, or default point of view, in addition to project data, rules to process the project data according to the point of view, and output formats to present the results of the project to the authoring entity and potentially to others, such as a community.

The client system 14 is also configured to receive feedback, typically from authoring entities and community members. The feedback may then be used to create, replace, update and delete various features, rules, outputs and other aspects of the system. In particular, feedback may be used to rate and comment on the specific outputs and specific rules used to generate the outputs presented by the system. Users may critique the specific outputs, suggest other outputs that they would find more helpful, point out corrections, and so forth. This type of feedback can then be used to improve the subsequent outputs and other aspects of the system. It can be difficult to obtain useful feedback on rules because they are implemented through computer code or algorithmic format. To enable rule refinement, the system accepts input of rules and outputs fired rules in natural language or pseudo-natural language (understandable to a non-expert-programmer) format, presents the rules through one or more templates, and then receives feedback that is used to modify one or more versions of the rule template.

In addition to general maintenance and provisioning, the system administrators 28 access the client system 14 to enter e.g., advertising data that is incorporated into the output produced by the system. The advertising data typically includes entity, product and service definitions for goods, services, offers, requests or needs provided by affiliates as well as links to their websites. The TMAO system is configured to identify when a particular affiliate's goods or services are relevant to a particular project and may embed referrals, recommendations, and links to the affiliate directly into the TMAO output.

The templates exposed by the client system 14 provide structured, semi-structured, and interactive user interfaces for soliciting information from authoring entities to define projects. Example templates include the “point of view”; “project description”; “project data”; “rules”; “import filters” and “output format” templates. Different authoring entities may utilize different sets of templates depending on needs of particular projects and default values may be used for template data not specified.

The “Point of View” template collects input data that the TMAO system uses to select and tailor one or more of the story structure, language modifiers, types of outputs, output formats, and other aspects of the project to be most appropriate for the particular user and purpose. The point of view considers one or more factors such as the role of the author (e.g., CEO, in-house attorney, outside counsel, etc.), the subject matter (e.g., area of technology or sciences), the purpose, key question or driver of the project (e.g., competitive market analysis, patent freedom to use analysis, state of the art analysis, etc.). For example, marketers are usually interested in seeing certain types of data presented in certain formats, while legal counsel are usually interested in seeing other types of data presented in alternative formats. Similarly, varied types of information are typically presented in e.g., a competitive market analysis versus e.g., patent landscape analysis. Desired output content, design and structures, such as data to be displayed in graphs, charts, videos and the like may also be specified.

The “project description” template is optional but may be used to further define the project to be conducted. A wide range of potentially pertinent data may be specified, such as prior projects related to the same subject matter, feedback to be incorporated into the study, specific factors to be considered in the project, a specific target audience, and so forth.

The “project data” template is used to identify the source data, which may be provided directly to the system, identified for access over the network, or defined in any other suitable manner. In many cases, the authoring entity will have already identified the specific information to be considered in the project. In other cases, electronically accessible databases or online document repositories may be designated and search engines may be used to identify project data through a search of electronic documents, scraping of web pages, collection of data feeds, and aggregation of other data sources that may be indexed by the search engine.

The “rules” template identifies rules to be used in processing the project data. Taxonomies are an important class of rule sets, which contain tag instructions that categorize data based on rules utilizing e.g., an industry lexicon and meanings (e.g., synonyms). Terms within the project data, e.g., records or documents, which may be individual words, parts of speech, proper nouns, noun phrases, clusters, ngrams, extracted entities, numerical descriptors, statistical descriptors, temporal descriptors, and the like, are tagged with the terms listed and grouped by the taxonomy categorization rules, thereby allowing data to be extracted based on e.g., meaning or pattern matches. A wide range of other rules may also be specified for identifying, tagging, extracting, removing, preparing, grouping, analyzing, scoring, sharing, and presenting numerical or text items.

The “rules” template may also be configured to identify a rule, translate the rule into a (pseudo) natural language description (or retrieve the description from metadata), and present the algorithm for consideration by an authoring entity. The rule may also be paired or linked with the data on which it has previously operated and the result it previously produced in a particular project. This allows the individual rules to be reviewed, commented on, edited, versioned, and augmented by the authoring entities (this effort is generally referred to as the CRUD—create, replace, update, delete—feedback improvement process). The rules may also be presented to one or more users in the community on a case-by-case basis to be reviewed, commented on, edited, and augmented with new rules by the community. This provides a powerful mechanism for developing, reviewing and improving the rule set through iterative experience with specific projects and multifaceted feedback. Rules receiving improvements may be linked to respective versions so that subsequent authoring entities, users and community members can determine which version to leverage in a particular project or feedback activity.

The “import filters” template allows the authoring entity to identify existing import filters and/or design new filters. Import filters are an important class of rule sets typically used to parse and prepare extracted project data as the data is entered into the TMAO system. That is, a taxonomy rule set may be used to categorize and tag data items in the source project data, based on meaning. An import filter rule set may then be used to select a particular meaning for extraction (i.e., filter the data), prepare the data into a desired format, and enter the extracted data into the TMAO database in the desired format. In other embodiments, the import filter template may be applied to project data to enable data extraction, and be used prior to or exclusive of any taxonomy rule set.

The “output format” template allows the authoring entity to identify output formats in which to display or share project results, as well as to design new output formats. Output formats are another important class of rule sets that are typically used to specify how the processed data is to be presented by the TMAO system. The authoring entity may already have output formats and designs that it wants to see, such as bar charts of particular statistics, portals to specific websites, video views and so forth. Design choices may include all those enabled by cascading style sheets (CSS) in e.g., HTML 5, and any other graphical design choice, e.g., storyboarding, wire framing, pagination, layering, layout, grids, motion planning, animation, audio/video integration, masking, image mapping, and the like. They may also design new output formats on a project-by-project basis, in a wide range of formats, comprised of e.g., (static or moving) text, raster, vector or point cloud data, with intention for digital or physical presentation

The client system 14 may use additional features to gather input data from the authoring entities, such as structured and semi-structured forms and intelligent questionnaires. The intelligent questionnaire can be an interactive, branching question and answer procedure used to solicit increasingly specific data as an authoring entity moves through the questionnaire. Subject matter-specific templates, structured and semi-structured forms, and intelligent questionnaires may be developed, stored, retrieved, and CRUD improved through user or community member feedback on an ongoing basis.

Through the client system 14, the server system 16 receives the template data and other elements defining a project and runs the TMAO system to produce and present output in desired or Point-of-View-specific formats. While the operating procedure may vary from project to project, a typical procedure may include applying an import filter to extract data items having specific tags or other attributes, preparing the extracted data into a database ready format (e.g., formatting the data items into structure corresponding to database fields), applying a subject matter specific taxonomy rule set to tag text and/or numerical data items in the project data, loading the extracted data into a database (e.g., one database record for each document processed in source project data, and one field in each record corresponding to each tag applied), processing the database as specified in the Point of View-specific analytical rule set (e.g., sorting, prioritizing, computing statistical analyses—all selectively applied to focus on data most likely to be relevant to the authoring entity's point of view) and providing the processed data to the output generators for presentation based on the point of view (e.g., display natural language text composed by the system, display statistical data, link portals to websites, play videos). The output may describe situations, suggest options, reach conclusions and embed advertising data deemed acceptable as determined by the point of view, such as referrals, recommendations and links to affiliates.

The TMAO output is then reviewed by the authoring entity (human, computerized) for feedback, which may result in one or more additional iterations of running the project with a range of refinements. The authoring entity may also be exposed to view top level advertising data embedded on TMAO project or output screens (e.g., affiliate recommendation with logo button—qualifying as a first-level advertising exposure), click to view additional advertising stored within the TMAO system (e.g., brief affiliate description, brief product or service description, and link to affiliate website—qualifying as a second-level advertising exposure), then click through to the affiliate's, website (now qualifying as a click through advertising exposure, where a user then may engage in additional advertising exposures (now qualifying as marketing lead advertising exposure), and make purchases (now qualifying as a marketing buy advertising exposure). This may thereafter trigger compensation to the operator of the TMAO system, which may be computed based on e.g., the number and types of advertising exposures.

Typically as specified by the authoring entity, the output and other project data (particularly the fired rules and associated results) may be shared with a community for review and feedback, which may result in additional advertising exposures and one or more additional iterations of running the project with a range of refinements. The system may also implement community incentives to encourage and compensate for useful feedback. For example, a rating system may be used to create and update reputational indicators for reviewing entities; credit may be provided (e.g., points for purchasing publications through the TMAO system) for providing reviews and reviewing reviews to rate the reviewers; or monetary compensation may be paid.

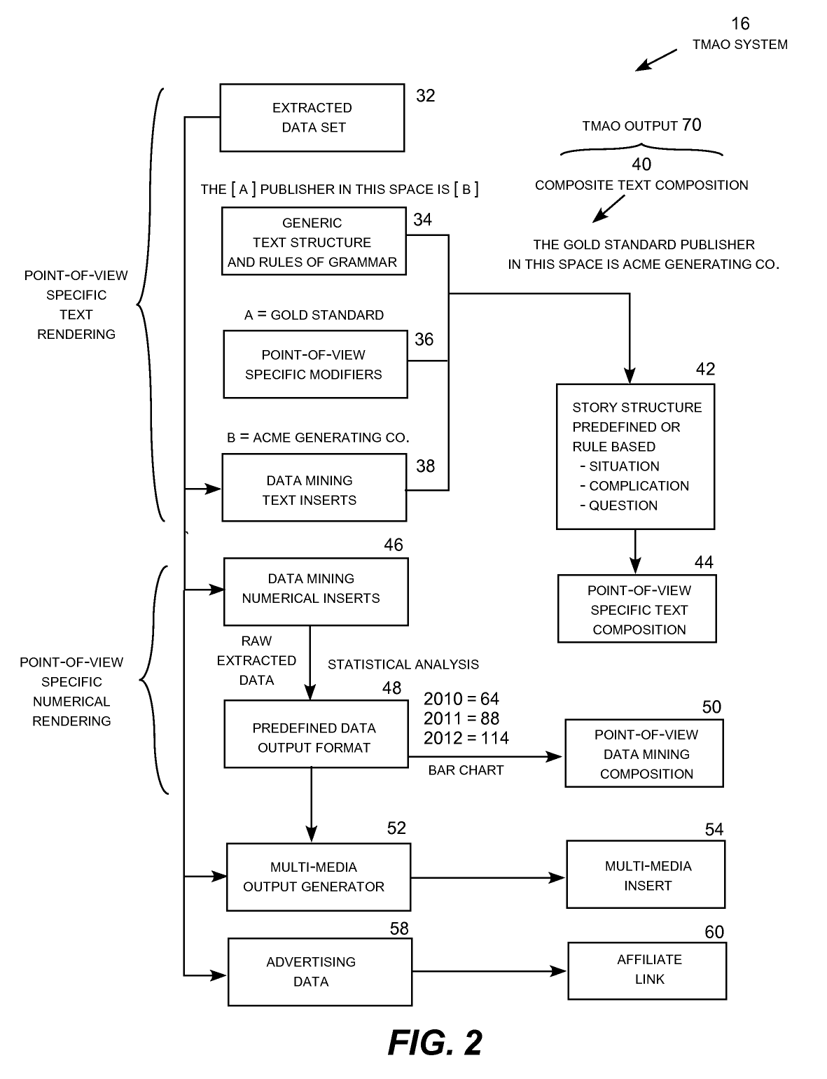

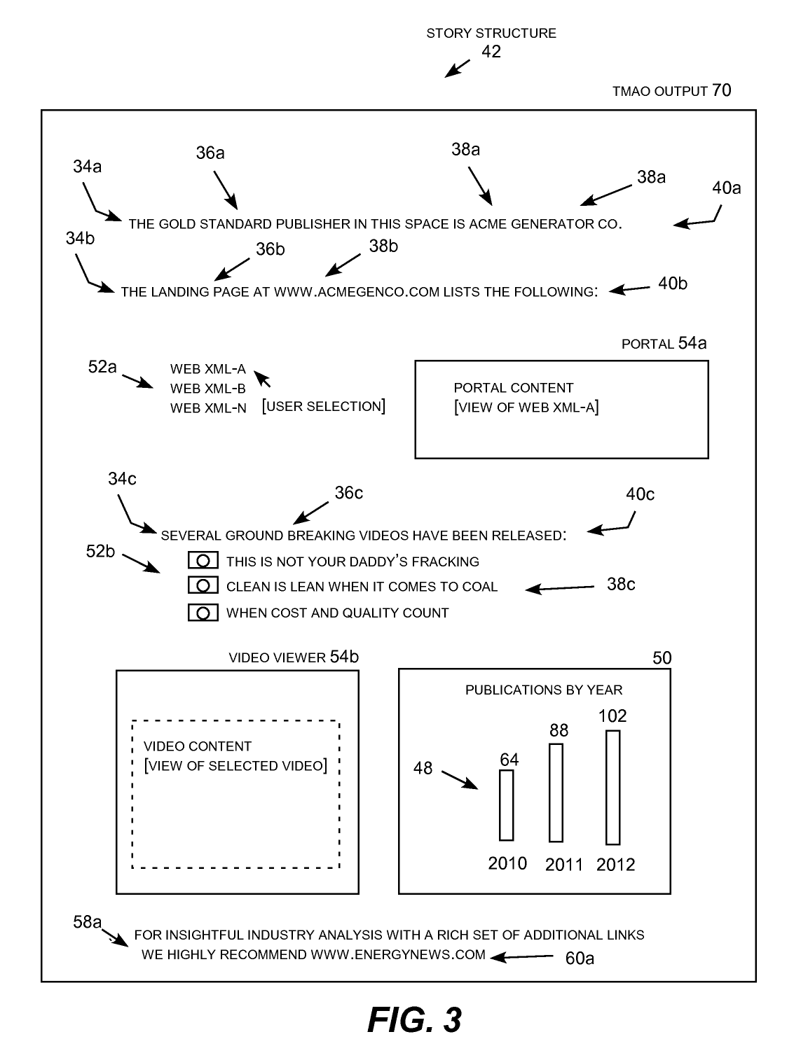

While a wide range of processing may implemented, including functionality developed through use of the TMAO system, FIG. 2 is a process diagram providing one illustrative example of processing performed by the TMAO system. FIG. 3 is a user interface diagram illustrating an example output display generated by the TMAO system, which shows certain elements in common with FIG. 2. Referring to FIG. 2, Blocks 32-44 illustrate Point of View specific text rendering and blocks 32 and 46-60 illustrate Point of View specific numerical data rendering. Blocks 42-44, 50 and 60 illustrate TMAO output 70, a display of which is illustrated on FIG. 3. It will be appreciated that FIGS. 2 and 3 show a simple example for the purpose of illustrating the principles of the invention and that an actual TMAO output would typically include many pages or sequences of output and varied textual compositions, data compositions, or multi-media inserts of greater complexity.

In block 32, an extracted data set is obtained from the project data based on the point of view determined from the project. For example, the data may be extracted using one or more taxonomies and import filters to identify, extract, categorize, prepare, and load the extracted data into defined records and fields of the TMAO database. In block 34, a set of generic text structures and rules of grammar is selected based on the point of view. The generic text structure typically includes a system of natural phrases with “fill in the blank” receipt fields for receiving text mined from the extracted data. The “fill in the blank” receipt fields may include both grammatical modifiers (e.g., adjectives, adverbs) as well as grammatical nouns (e.g., subjects, objects) and grammatical verbs (e.g., actions, processes) to be filled in by extracted data and expressions selected to be best suited to the point of view. For example, one set of expressions may be considered suitable for legal points of view (e.g., non-euphemistic language or otherwise avoiding or using certain legally meaningful terms as indicated by the point of view, such as pro-plaintiff or pro-defendant), while another set of expressions may be considered suitable for market evaluation points of view (e.g., more colorful, opportunistic or future-oriented language), or demographic evaluations (e.g., using established demographic categories).

To provide one simple example, a generic text structure may be “The [A] publisher in this space is [B]” where [A] is a modifier to be inserted based on the point of view and [B] is a data mining text insert. The modifier [A] is typically contained in the rule set and selected based on the point of view determined for the project; whereas the data mining text insert [B] is typically extracted from the project data. The point of view for the project is determined by the TMAO system from the information entered by the authoring entity through point of view templates exposed by the user interface, which may be augmented by additional input solicitation such as an intelligent questionnaire and additional structured or semi-structured input forms completed by the authoring entity. The generic text structure is typically referenced by (in one embodiment) or contained in (in another embodiment) one or more rule sets and may be selected based on the Point-of-View determined for the project. In most cases, the generic text structures may be used for multiple points of view and may be further selected or apportioned based on the specific points of view determined for the project. In other cases the generic text structures may be selected based on a relationship to e.g., a tag, a category, a rule or modified based on specific field values from the point of view template for the project. In any case, the generic text structures are configured to be ready for receipt of modifiers and data mining text inserts, which are provided in the syntax provided by the corresponding features of TMAO system, in order to create grammatically formatted composite text compositions in natural language sentence and phrase format.

To further illustrate this process, Block 36 contains point of view-specific modifiers. In the context of the specific example, the modifier [A] selected for the specific point of view for the project is “gold standard.” This particular modifier may have been selected from a group of modifiers having similar meaning that are considered more appropriate for other points of view. For example, the set of potential modifiers for this particular insert location on the generic text structure could be “gold standard”; “leading”; “most prolific”; “highest quantity,” with “gold standard” selected for insertion based on the specific point of view for the project. Block 38 illustrates the set of data mining text inserts for the project, typically extracted using one or more of taxonomy rule sets, import filters, and analytical rules specified by the authoring entity through the templates exposed by the user interface. In the specific example, “Acme Generating Co.” is selected from the extracted data as the data mining text insert [B] as the publisher with the largest number of publications extracted from or identified in the project data based on the point of view determined for the project. The generic text structure, the modifier insert [A] and the data mining text insert [B] are then combined to create a composite text composition 40, in this example “The gold standard publisher in the space is Acme Generating Co.”

Block 42 contains predefined story structures and/or rules for creating story structures based on the point of view for the project. For example, the story structure may be created through rules that create the story in, e.g., a “situation, complication, question” format developed through input solicitation such as an intelligent questionnaire that creates the story structure as it branches through a question and answer interaction with the authoring entity. Other linear and non-linear story structures may be used, comprising plots, schemas, tropes, arcs, archetypes or otherwise, provided such structures can be systematically organized, conditionally populated, and output in communicative compositions according to aspects of the present invention. Block 44 illustrates insertion of the composite text composition 40 into the Point-of-View specific story structure 42. Referring to FIG. 3, a TMAO output 70 for the specific example is shown. The specific story structure 42 is reflected in the selection, arrangement and format of the text, data and multimedia items included in the display panel. The composite text composition, “The gold standard publisher in the space is Acme Generating Co.,” has been inserted as item 40a with additional composite text compositions 40b-c shown as additional examples. The generic text structure 34a, modifier insert 36a, and data mining text insert 38a for the composite text composition 40a are also called out, with additional generic text structures 34b-c, modifiers 3b-c, and data mining text inserts 38b-c shown for the additional examples.

Returning to FIG. 2, blocks 32 and 46-60 illustrate point of view-specific numerical data rendering. Block 46 contains the raw data used to create the data mining numerical inserts extracted from the project data. In this example, identifiers for at least the publications by Acme Generating Co. for the years 2010, 2011 and 2012 have been extracted from the project data and loaded onto the TMAO database. At this point statistical analysis is typically applied to the raw extracted data, in this case summing of publications by year. This is facilitated by loading the extracted data into the TMAO database, where is can be sorted, counted, statistically analyzed, and formatted as desired. Block 48 illustrates the data mining numerical inserts as they have been analyzed and formatted for the point-of-view specific based structure 42. The specific example shown is the publication years and numbers of publications (2010=64, 2011=88, and 2012=1140), provided in the format needed for the corresponding output generator to create the point-of-view specific data mining composition 50 for the data, in this case a bar chart. FIG. 3 shows the output generator 50 illustrating the data mining numerical inserts 48 in the form of a bar chart, as specified by the point-of-view story structure 42 determined for the project.

Returning again to FIG. 2, Block 52 illustrates a multi-media output generator 52, which typically links to multi-media data contained in the project data. The multi-media links are provided to a multi-media insert 54, which formats the multi-media for display at the location and in the format specified by the point-of-view story structure 42. FIG. 3 shows a first example in the form of web links 52a and portal viewer 54a which allows a user to view live data located on various websites or other storage locations. A second example includes video links 52b and video viewer 54b which allows a user to view videos located on various websites or other storage locations. In this example, the titles of the videos have been extracted and displayed as data mining text inserts 38c. It will be appreciated that virtually any type of multi-media data that can be accessed electronically may be displayed or linked to in this manner.

FIG. 2 also shows Block 58 containing advertising data, which may include a variety of information usually from trusted affiliates (or affiliates of trusted affiliates) with which the operator of the TMAO system has established relationships. Typically, these relationships include a compensation model under which the operator of the TMAO system may receive compensation for commerce facilitated by the TMAO system, e.g., advertising exposures including onsite exposures, clicks through to affiliates, purchases from affiliates, registrations with affiliates and so forth. Block 58 further represents the generation of textual and data compositions (which may be composite compositions) containing referrals, recommendations and/or other statements and data pertaining to products, services, and affiliates. Although any type of advertising data may be incorporated into the TMAO output, Block 60 illustrates the display of links 60 to affiliate websites. FIG. 3 illustrates incorporation of the advertising data into the TMAO output, in this example a recommendation 58a containing an affiliate link 60a. Again, it will be appreciated that virtually any type of advertising data including multi-media data that can be accessed electronically may be displayed or linked to in this manner.

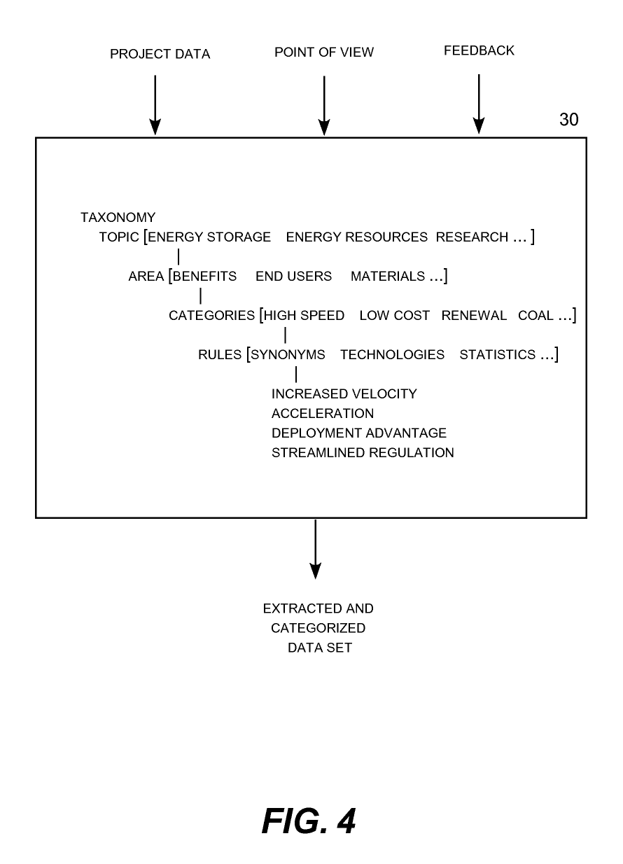

FIG. 4 is a data organization diagram of a taxonomy rule set 30 using in the TMAO system. The specific taxonomy is created and may be modified over time based on, e.g., the point of view, the project data, and feedback received from the authoring entity and potentially from a community of reviewers. While the taxonomy rule set may contain a wide variety of rules, the taxonomy is an important class of rule set used to categorize data. Each taxonomy is comprised of hierarchical data and a rule structure specific to one or more particular topics. FIG. 4 shows an illustrative portion of a hierarchy, which may have as many levels as desired. In this example, the highest level of the taxonomy is the topic and higher levels not shown in the example may include, e.g., categories of topics, such as areas of technology, liberal arts, language selection and so forth. Several topics have been defined (which may be implemented, e.g., as tabs on the user interface) with “energy storage devices” being the selected topic. Several areas are defined under the selected topic with the selected area being “benefits.” Similarly, several categories are defined under the selected area with “high speed” being the selected category. Continuing with the specific example, several rules are defined under the selected category with “synonyms” being the selected rule. A list of synonyms for the selected category is then displayed under the selected synonyms rule. This rule applies a metadata tag for the category (high speed) to the project data conditioned upon the presence of one or more of the synonyms in the data. One skilled in the art will understand that this rule could be further specified to apply to e.g., all the project data, a portion of the project data, or a set or subset of a field within the project data. In one embodiment, this further allows an import filter to specify the category “high speed” for subsequent extraction, which may cause, e.g., tagged synonyms, tagged records or other portions of tagged records to be extracted from the project data and loaded into the TMAO database, typically with one record created for each document processed and the extracted data loaded into a database field labeled with the category “high speed.” It will be appreciated that rich sets of taxonomies with corresponding import filters can be defined in this manner to implement sophisticated data extraction schemes with any desired level of granularity. In addition, the taxonomy can be developed through experience and feedback to effectively learn and apply a lexicon currently in use in a particular industry sector, as that lexicon may change over time.

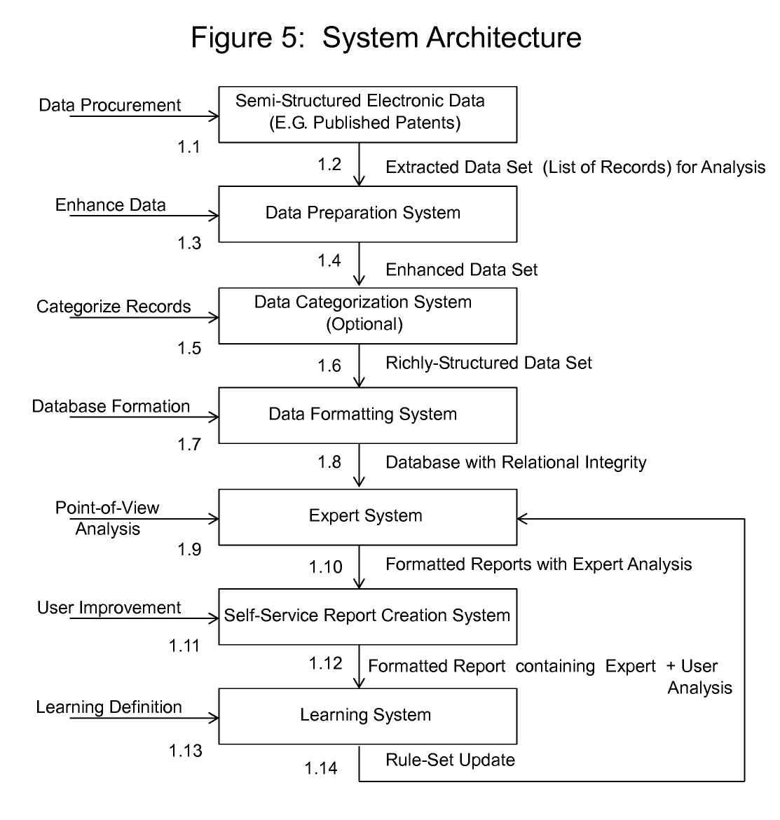

FIG. 5 illustrates an example system architecture for the TMAO system. Data procurement may utilize structured and semi-structured electronic data, which often represents documents, e.g. published patent data, technical literature data, published news data, litigation data and the like. As exemplified in (1.1), such data are available for electronic retrieval from many sources around the world. Several tools and online services, e.g. Espacenet, the online search and data retrieval service of the European Patent Office, aggregates data from multiple bibliographic, full-text and metadata sources and provides a single interface that enables a user of the service to extract a user-specified subset of data from an aggregate data corpus. In the current TMAO system, the data procured may be in the format identical or similar to data provided by Espacenet. In addition, the invention may utilize similar types of data from an array of sources too numerous to name completely. Nonetheless, each source of semi-structured data will deliver formatted data according to some structuring standard, such as CSV, tagged text, RSS/Atom feeds, or XML. The format of the procured data is organized into a list of Records, depicted by (2), each record representing a logical unit of semi-structured data, e.g. published article, published patent, legal filing, etc. Records may be further identified by a key or unique identifier to explicitly distinguish one logical unit from the next. In other embodiments, a key need not be present, and one can be assigned if needed by an import filter or during data preparation.

For Data enhancement, the extracted data set (1.2) may retain the characteristics of the overall corpus of semi-structured data. Alternatively, the existing structure may be removed and new structure applied, e.g., unifying XML tags across formerly heterogeneous record structures. Preferentially, data in the data set is only partially structured, and therefore data elements critical to downstream analyses are in unconstrained free text record portions. In some cases, the data are “dirty”, e.g. contain spelling errors, inconsistency or outdated elements. For example, often proper names are inconsistently formatted, e.g. “University of Pennsylvania” and “Univ. of Penn” may both utilized within the data set to refer to the same institution, and semantic relationships across data elements may not be represented explicitly, e.g. multiple patents belonging with identical assignee.

The Data Preparation System, depicted in (1.3), is designed to address these deficiencies present in the Extracted Data Set (1.2). This system may translate all text into a single language such as English. It may extract quantitative information, such as dates, years, units of measure and the like. It may unify proper nouns such as names, using automated techniques such as fuzzy logic, regular-expression pattern-matching and business rules to enhance the data set prior to analysis. Unifying proper nouns may occur, for example, by correcting spelling errors or validating names against a dictionary of known terms. In addition, records in the data set may be de-duplicated, with identical or similar records removed by recognizing, comparing and acting on redundant data within records contained in the data set. Further, records in the data set may be cleaned, normalized or unified using a preferred taxonomy. Thesauri—which in one embodiment can contain regular expression-based lists of “child” terms equivalent to a “parent” term—may be applied in order to adopt a canonical term that will represent a set of synonyms linked to each canonical term within a given thesaurus. Multiple thesauri may be utilized during this data preparation, with each thesaurus applied to an appropriate portion of the data elements within a record. For example, an Institution thesaurus may be used to recognize different variations of University, Company, etc. names occurring in specific portions of a set or subset of data records, and each variation will then be replaced with the single canonical preferred form, associated with each Institution. Additional data preparation may also include use of semantic, natural language processing, entity extraction or other libraries to utilize lexical, grammatical and statistical techniques to extract relevant data elements from within different records. It is not the role of the Data Preparation System to analyze or interpret the data or any relationships or mappings made possible by the data; rather, the role of the Data Preparation System is to explicitly apportion, adjust and unify data elements so that relationships may later be represented in order to facilitate downstream analysis and interpretation.

The output of the Data Preparation System, depicted by (1.4), is a cleaner, better structured data set more suitable for sophisticated categorization, reasoning, analysis and interpretation. This is achieved by the various methods described above that explicitly represent information that was previously only latently present in the Extracted Data Set (1.2). The resulting explicit representation facilitates downstream processing and directly translates into increased value from TMAO system output, depicted by (10).

The TMAO system may also categorize records. Often, the cleaned, enhanced records (1.4) are still not sufficiently organized to support analysis in the vernacular required by the User Point of View, depicted in (1.9). In these cases, it is useful to capture groups or clusters of records that are aligned by semantics or commonalities (such as associations with a known feature or benefit) according to a taxonomy, and to bin the records in the data set into one or more categories. This is the purpose of Data Categorization System (1.5). For instance, a landscape topic of “foot-wear” may have described by the following list of areas: “shoes”, “sneakers”, “slippers”, “boots” and “flip-flops”. Each area may be further described by a set of categories. For instance, “sneakers” may be categorized by “cross-trainers”, “tennis”, “running” and “walking”. Employing such a taxonomy can benefit an analysis in several ways. Firstly, a more fine-grained categorization permits a more nuanced analysis. For example, distinctions can be made between “sneakers” and other types of foot-wear. Similarly, distinctions can be made between “cross-trainers” and “tennis” sneakers. Relatedly, employing a taxonomic categorization can introduce another dimension of organization of data that is simply not present in the initial data set. This new dimension may enable additional analyses that could not be performed otherwise.

Records may be binned semi-manually or automatically. If semi-manually, it is through an iterative process of defining one or more sets of rules or terms for each leaf node—i.e. bottom-level category—in the taxonomy. The methods of rule or term matching can vary; with textual data, a Boolean expression—i.e. one that evaluates to “true” or “false”—or a series of regular expressions—i.e. terms that flexibly match a range of textual variation, rather than just matching a single literal instance of text (e.g. the regular expression foot(\s)?wear” matches both literals “foot wear” and “footwear”. The categorization strategy may be developed iteratively through development of increasingly accurate and sensitive search terms, as judged by the curator developing and refining those terms or as judged by a scoring algorithm that compares the strength of a match to e.g., precision, recall, uniqueness or commonality of covered terms, or to past matches made by one or more users. This may be done in order to better categorize the cleaned data set. If records are categorized automatically, one or more thesauri may be used. These thesauri may contain regular expressions and/or synonym rules that have been included into the thesaurus based on one or more criteria: e.g., determined by the preference or point of view of a single user; determined by winning a poll taken by a number of users; determined by presence or absence of the term or a related term when compared to a dictionary, traditional thesaurus or specific list of known key terms; presence in an industry-standard ontology; frequency of association in reputable texts; determined by a score resulting from an analysis of relevance.

When the categorization process is deemed sufficient by e.g., a user decision, a benchmark score or otherwise, the enhanced data set has been transformed into a Richly-Structured Data Set (1.6) that can support additional analyses. Prior to performing rich analysis, the Richly-Structured Data Set (1.6) must be transformed into a database format. The database is provisioned to store records containing the extracted data in accordance with the data extraction methodology employed. For example, the project data may be tagged and categorized by meaning using a taxonomy specific to the subject matter associated with the project data and an import filter may specify tags for data extraction. A database record may then be created for each document processed with each record containing a field for each tag identified by the import filter. Such database formats may be based on structured query language (SQL) e.g., databases from Oracle and Microsoft or the format may be, e.g, “no SQL”, as used in databases such as Hadoop, MongoDB and others. Whatever database format is utilized, the database produced must maintain relational integrity—the relationships between data elements in the database must be faithful to the relationships within the underlying data.

The Database with Relational Integrity depicted in (1.8) can be produced through various methods using Data Formatting System (1.7). For example, the Data Categorization System (1.5) itself may have a data export function that produces appropriately-formatted XML data. Sometimes, exporting functions will be limited to comma-delimited or tab-delimited data (e.g. Excel spreadsheet) that is insufficient for facile interrogation by a database query language. In these cases, simple ETL—Extract, Transform, Load—scripts can be written that transform this data into a Database with Relational Integrity (1.8) that is suitable for analysis by the TMAO system depicted in (1.9).

The TMAO system determines a point of view for that project and uses the point of view to shape the project including, for example, the textual and numerical presentations of the outputs. Once a Database with Relational Integrity (1.8) is formed, it is ready for input into the TMAO system (1.9). The point of view of the user, depicted in (1.9), provides the instructions to the TMAO system to detail e.g., the user role, the analytical goals and optionally advertising preferences that will then be the focus of the analysis performed by the TMAO system. In this way, the Point of View Definition guides the execution of a set of rules within the TMAO system that operate over the Database with Relational Integrity to deliver a Formatted Report with Expert Analysis, depicted in (1.10), that address the analytical goals set forth in the Point of View Definition.

The TMAO system accesses the Database with Relational Integrity via a query language that is able to provide access to the underlying data, in a fashion that is faithful (e.g., respects the relational integrity and semantics of the underlying database), reproducible (e.g., the same query over the same data returns the same result) and deterministic (e.g., output is predictable given the input).

The TMAO system has sets of rules that, in a preferred embodiment, map to sets of report templates. When a set of TMAO system rules are executed, this triggers creation and/or assembly of the data elements of a narrative (and optionally illustrated or animated) report—i.e. textual, numeric, symbolic and/or graphical elements—to be collated in a user-friendly format to be produced as a web-based, print-based or interactive output. The Point of View Definition is described by a template. Elements of the Point of View template are mapped to rules within the TMAO system. Therefore, the Point of View Definition highlights which specific sets of rules are likely applicable within the TMAO system. The likely relevant sets of TMAO system rules then may be listed for user approval or may automatically (without further approval) trigger the analyses that are necessary to produce the portions of the narrative template that collectively address the analytical goals requested by the Point of View definition. For example, a Point of View definition may be created so a user or set of users can identify emerging organizations in the “Footwear” competitive landscape. This definition would trigger a TMAO system module with a set of rules to analyze database information for those organizations that have accelerated their patenting in “footwear” technology recently (which may be defined in the Point of View template as “in the past five years”).

An example of a rule is as follows:

Input:
a. Co-occurrence statistics of the number of records held by a single patent assignee and the application year associated with each record
b. Co-occurrence statistics of the number of records held by a single patent assignee and the publication year associated with each record
c. Cosine cross-correlation values between records sharing assignee data and technology category data

Task:
d. Identify an emerging player (Assignee Y) relative to a chosen technology leader's focus area (Assignee X)

Point of View:
e. Players with significant recent portfolios in similar areas need to be detected early

Output(s):
f. “Assignee Y is C % likely to be a significant emerging player relative to Assignee X. This is because Assignee Y is most similar to Assignee X in technology categories M and N.”
g. “The system has not detected emerging players of significance relative to Assignee X.”

Algorithm:
h. IF Assignee X has the largest number of granted patents between years 1995 and 2012,
i. AND IF Assignee Y has a granted patent portfolio size in the top 20,
j. AND IF similarity in technology category focus between

Assignees X and Y>A %,
k. AND IF>B % of Assignee Y's portfolio was created between 2008 and 2012;
l. THEN Assignee Y is an emerging player concerning Assignee X with probability of C %.

The actual rules could be more complex, or depend on outcomes from other rules. Note also that the knowledge of experts or other users will be codified to help quantify and express what are often considered to be subjective criteria, such as the A, B, and C parameters or the phrasing style used above. The resulting analysis may then be included as part of the Formatted Report with Expert Analysis (1.10), and may for example, include information on organizations, e.g., shoemakers Crocs and Uggs. In another example, the Point of View definition might indicate that the user is a new product manager in need of assistance in picking a new technology or requiring the filing of a patent in China. The resulting analysis would then include names and contact information of technology experts in e.g., gel insoles or of law firms with e.g., patent prosecution practices in China.

In a preferred embodiment, the Formatted Report with Expert Analysis consists of an intuitive report or presentation that statically or dynamically interplays text and graphics to align analytical conclusions expressed in words and numbers with graphical elements that depict the phenomena being analyzed and optionally including advertising or suggestive opportunities for a user.

User feedback, including feedback from authoring entities and a community, as desired, may be used to improve the TMAO system on a discrete or continual basis. A Formatted Report with Expert Analysis (1.10) is provided to the Self-Service Report Creation System (1.11). This System enables one or more users to modify the Formatted Report with Expert Analysis (1.10) by exposing one or more underlying mechanisms—i.e. templates, rules, thresholds, parameters, preferences, points of view—within the TMAO system.

In one embodiment, this allows a local, temporary copy of the TMAO system to be modified and executed during the user session, but it does not permit modification of the TMAO system itself. In another embodiment, there is only one version of the TMAO system available, though the system has rules to expose its underlying mechanisms, and accept variations as input by one or more users. In this embodiment, the TMAO system may then be re-run with these new inputs, or it can otherwise retain the inputs without running until a human moderator or subsequent rule approves one or more of the inputs. This functionality allows one or more authoring entities to further tailor the creation of a Formatted Report containing Expert & User Analysis (1.12) that reflects the output of the system as well as the expertise and/or analytical requirements of one or more users. The Formatted Report can be enhanced through several types of changes to the underlying mechanisms of the embodiments of the TMAO system. For example, mappings between Point of View Definition and TMAO system rules can be modified. Similarly, mappings between TMAO system rules to elements of the Narrative Report template can be modified. Templates themselves can be modified or extended. Rules themselves can be modified and new rules can be introduced.

In this fashion, the Self-Service Report Creation System (1.11) allows a user to transform a Formatted Report with Expert Analysis into a Formatted Report with Expert & User Analysis (1.12) that further reflects both the expertise and analytical requirements of the user. In some embodiments, an audit trail of TMAO system modifications performed by the user within the Self-Service Report Creation System is captured, and is communicated silently (i.e. not visible to the user) as input to the Learning System (1.13).

Feedback based model refinement may be implemented through a learning definition. The function of the Learning System (1.13) is to leverage the new expertise expressed during use of the Self-Service Report Creation System by incorporating a subset of the changes described above into a version of the primary TMAO system. This enables the TMAO system, and the Formatted Reports it generates, to evolve over time, improving depth, breadth, flexibility and expressiveness.

The Learning System is designed to facilitate the review of TMAO system changes and to partially automate the knowledge engineering of one or more users. In one embodiment, the Learning System enables a human moderator by providing a set of changes by one or more users alongside the relevant pre-existing components of the primary TMAO system. The human moderator then performs an evaluation and either accepts or rejects a change or set of changes, thereby providing feedback. In another embodiment, the TMAO system may run subsequent rules (either automatically or actuated by a human moderator) to either accept or reject a change or sets of changes. The Learning System incorporates accepted changes into the primary TMAO system, by exporting feedback as Rule-Base Updates (1.14) back into the TMAO system. These updates may permanently affect the TMAO system, become optional versions to be selected by current or future users, or in other embodiments may only affect the TMAO system for a limited amount of time. In some embodiments, outputs of the Learning System may only affect the TMAO system as experienced by a single user or in other embodiments, a specific collective of users.

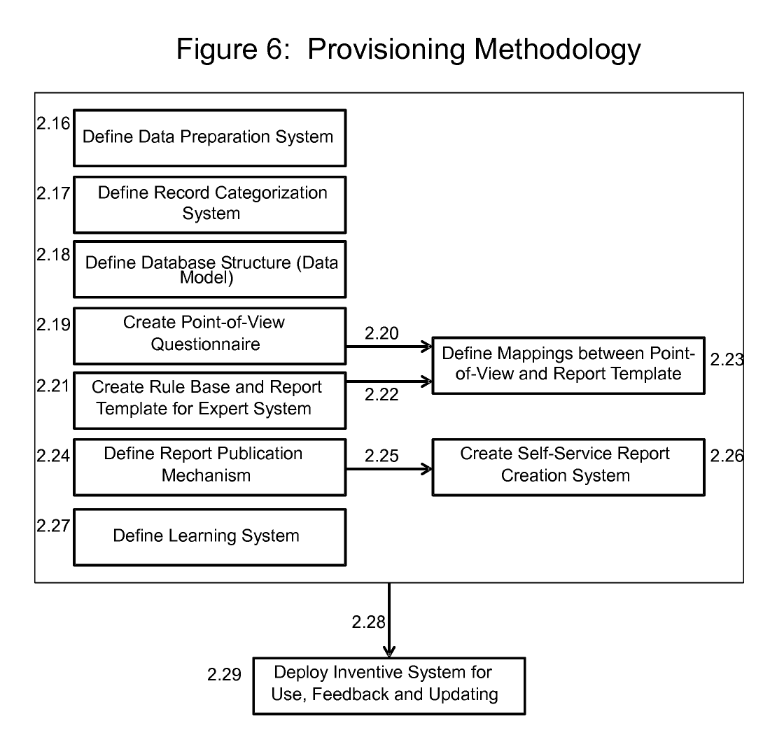

FIG. 6 illustrates a provisioning methodology for the TMAO system. Within the Define Data Preparation System (2.16), users identify one or more data sources that contain the data records that they wish to analyze, as well as one or more methods to extract data records from those sources. In one embodiment, the entire data source (or sources) is extracted for analysis. In another embodiment, a subset of a data source—rather than an entire data source—may be required for analysis. In this embodiment, users must specify the subset through some combination of preferences, e.g., search terms, filters, thresholds and parameters that unambiguously identify a subset of records for extraction.

Once data is extracted, dictionaries, lexicons, thesauri, preferred terms and controlled vocabularies may be utilized to clean and enhance the data, as described elsewhere.

Within the Record Categorization System (2.17), if users choose an embodiment in which they categorize data after preparation, users must specify (originate, select from a list of options, or modify) both a categorization structure of the data set they wish to analyze, as well as a method for determining which categories each data record should, in turn, be assigned. One or several methods may be employed to perform this function, for example, providing a user with suggestions for or access to rules such as exact matching to a predefined taxonomy rule set, regular expressions, fuzzy (e.g. approximate) matching, probabilistic matching, Boolean conditionals, etc.

Within the Define Database Structure (Data Model) system (2.18), users must employ a data model, encode that data model within the accepted syntactical constraints defined by a data definition language such as SQL or XML, and then populate that data model with the data set to be analyzed such that relational integrity is preserved.

Within the Create Point of View Questionnaire system (2.19), users must adopt a selective (e.g., multiple choice, free text input, interview) mechanism that interrogates users in order to ferret out one or more elements of their perspective that will be used downstream to guide expert analysis within the TMAO system. The user point of view may draw from a complex set of concerns, including, but not limited to, legal, competitive, financial, marketing, logistical, technical, scientific, social, political, economic, regulatory and theological issues.

In some embodiments, the point of view must be encoded and recorded on a persistent data store in a fashion that enables the TMAO system to access data within this persistent data store in order to utilize the point of view to guide expert analysis and reporting.

Within the Create Rule set and Report Template for the TMAO system (2.21), users must adopt, develop and/or refine a set of rules to deliver expert analysis derived from data within the database and to be guided by user requirements encoded within the user's point of view. These rules may take one or many forms. Forms may include, but are not limited to: IF-THEN statements, probabilistic rules, fuzzy rules or procedural code without an obvious Facts/Derived-Conclusion structure. Rules may be computed in forward-chaining, backward-chaining, neural network modes or a combination of these modes or another mode by which rules can lead to predictable outcomes given the data. Rules may or may not have confidence values associated with them.

In some embodiments, the user must employ mappings that relate elements between the point of view (2.20) with germane rules within the rule set (2.22) and germane elements within the report template (2.22). This is depicted in FIG. 6 by Mappings between point of view and Report Template (2.23).

Within the Define Report Publication Mechanism system (2.24), a user must adopt, develop and/or refine a template for the published output, e.g., a report or presentation. Elements in this template may be mapped to rules within the rule-base, and may contain variables that will be instantiated by the expert analysis. The report template may include heterogeneous types of data—such as text and graphics that you might see in a Powerpoint or PDF file—or it may contain just a single type of data—such as text that you might see in an RSS feed.

Within the Create Self-Service Report Creation System (2.26), the user may specify zero, or one or more of, create, replace, update or delete operations of TMAO system rules and/or elements within the published report template. Any create, replace, update or delete operation on the rule set may have the effect of changing the TMAO system analysis the next time the system is run. Similarly, any changing of elements within the published report template may change the content—i.e. expert analysis output—of the published report.

In another embodiment, the user may choose to create a new rule set variant, or new published report template variant, that become user selection options during subsequent uses of the TMAO system.

The Define Learning System (2.27) requires access to self-service reports and presentations created by (2.26) and can further evolve the TMAO system and report template through analysis of one or more outputs or content elements within one or more reports or presentations.

Any and all software, databases, ancillary files network access and other components required for operation must be deployed (2.28) and available to users when those elements are needed by the TMAO system. For example, the rule set does not have to be available during data preparation, but must be available during analysis.

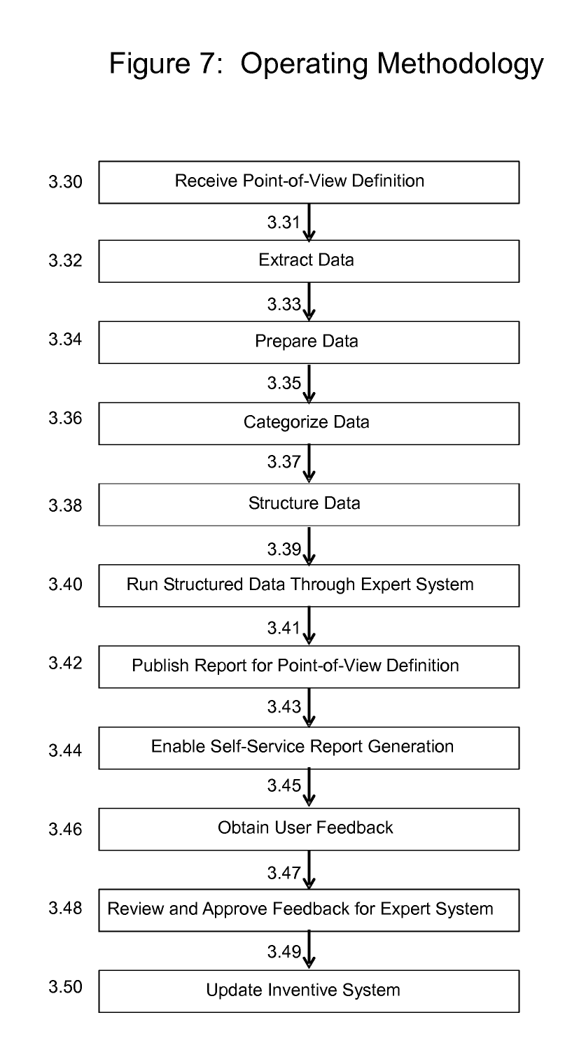

FIG. 7 illustrates an operating methodology for the TMAO system. The initial step in the operating methodology is the capturing of the Point of View Definition, depicted by (3.30), from the user(s). This can be accomplished in some embodiments through an automated process and through a manual process in other embodiments. For example, an intelligent questionnaire or form—an automated computer program that performs knowledge acquisition from an authoring entity—that writes to a persistent data store (e.g. to a database such as Microsoft Access or Oracle) can provide a fully automated method for capturing the Point of View Definition. In another embodiment, Point of View Definitions can be captured through human interviewing of the author, followed by human encoding of the Point of View definition in a persistent store. Hybrid approaches that utilize both automated and manual processes to obtain the Point of View Definition from a human or computer authoring entity may also be employed.

The Point of View Definition is critical to further downstream operation of the TMAO system, as it informs multiple steps in the process, including Extract Data (3.32) and Run Structured Data Through TMAO System (3.40).

The next step in the process is to Extract Data (3.32). Often, this is performed using tools such as Espacenet, which provides access to large corpi of semi-structured electronic data. The data itself can be heterogeneous, i.e. data can be extracted from bibliographic references, full-text patents and applications, literature published in journals, and many other data sources. The Point of View Definition provided by the user plays an important role in forming a search refinement and analysis strategy that will yield a data set of records germane to the users' analytical goals during downstream expert analysis. This may entail informing the sources to be searched, as well as defining or tailoring filters, thresholds and parameters used in distinguishing data records that satisfy search conditions (positives) from data records that do not satisfy search conditions (negatives).

The Extracted Data (3.33) provides the data inputs required for the next step, which is to Prepare Data (3.34) by cleaning and enhancing the data so as to improve the signal-to-noise ratio during downstream expert analysis. Without this step, there is a risk that critical information within the Extracted Data would lie fallow, undetectable by the TMAO system. In order to preserve the key function and focus of the TMAO system—that is to perform expert analysis—data preparation is optimally performed in advance, so as not to dilute the focus and compromise the design of the TMAO system, which could occur if data cleansing and data analysis steps were intermingled.

Once the data has been cleaned and enhanced (3.35), the data may be categorized according to manual, semi-automated or fully automated processes. In some cases, the nature of the preferred Point of View Definition as well as structure already present within the data—for example, IPC codes within a set of only patent data—is such that no additional Categorization is required. In this case, the Prepared Data is simply passed on to (3.37). When a discrete Categorization step is required, classification and binning of records is performed, and the resultant Categorized Data is transmitted on to (3.37).

Once the data has been categorized, the data (3.37) is transformed by (3.38) into a structured data representation language, such as XML or a relational data model. The purpose of this step is to facilitate downstream analysis by codifying the relational integrity in a format that enables the data to be queried with a language such as XPATH and/or SQL. When the data has been structured, as embodied in (3.39), the data is ready to be run through the TMAO system, as embodied by (3.40).

The TMAO system performs analysis over the Structured Data embodied by (3.39), as guided by the analytical goals and user-perspective described in the Point of View definition depicted in (2.19). The TMAO system is an automated computer program that can perform this analysis by emulating the decision-making ability of a human expert, by pairing an inference engine (using propositional logic, predicates of order 1 or more, epistemic logic, modal logic, temporal logic, or fuzzy logic) with a knowledge base (containing one or more rules expressed in natural language). The TMAO system generates structured but raw analytical output, often consisting of narrative text paired with graphics. This is transmitted as embodied by (3.41) in order to take the raw TMAO system output and develop a published output responsive to the Point of View Definition, as embodied by (3.42).

The role of this Point of View Definition component (3.42) is to take the structured, raw output in (3.41) and transform it to be presentation-ready to one or more users, by conveying the analytical results in terms of preferred structure and aesthetics, as well as ensuring that the data format conforms to the appropriate publishing mode. In addition, advertisements, contextual commerce and suggestive elements related to future purchases or affiliate messages may be integrated into a resulting presentation or report, based on the identity, stated goals, perceived needs, or similar needs of one or more users expressing a similar point of view. For example, (3.42) might take the data from (3.41) and transform this into e.g., a web page, mobile web page, Powerpoint slide deck, a PDF document or an RSS feed. In addition to creating an aesthetic, intuitive presentation, each of these presentation formats has particular syntax that needs to be met in order to be compliant with applications—such as Microsoft Office or Web Browsers—that can render these formats. It is the role of (3.42) to produce intuitive and compliant data, as described above and embodied by the data feed in (3.43).

The next step in the work flow accepts the data feed (3.43) and provides the user with the ability to perform Self-Service Output Generation, (3.44), in some embodiments enabled by allowing the user to modify and run their own local copy of the TMAO system. This component, (3.44) outputs a data feed (3.45) that is just like data feed (3.43), except that the content is generated by the modified TMAO system the user creates or contributes to in (3.44). Additionally, data feed (3.45) may contain hidden or silent data (i.e. data not fully visible—but [possibly partially visible—to the user) that contains the set of changes that the user made or contributed to in component (3.44) to the TMAO system.

This data may be fed into a component that identifies this hidden or silent data. The purpose of this component is to enable the possibility of user feedback to enhance the expertise within the TMAO system (3.46) by capturing the changes made by one or more users in the Self-Service Output step (3.44). This hidden data that describes the changes made by the user are then transmitted via (3.47) to a component, embodied by (3.48), that reviews and evaluates those changes.

This component (3.48), may be automated, a combination of a manual and automated process, or completely manual. One or more moderators may review one or more changes made by one or more users and decide which changes should be incorporated into the primary TMAO system. These changes are communicated, as embodied by (3.49) into the final system component, embodied by (3.50), that incorporates those changes approved by the modifier into the primary TMAO system.

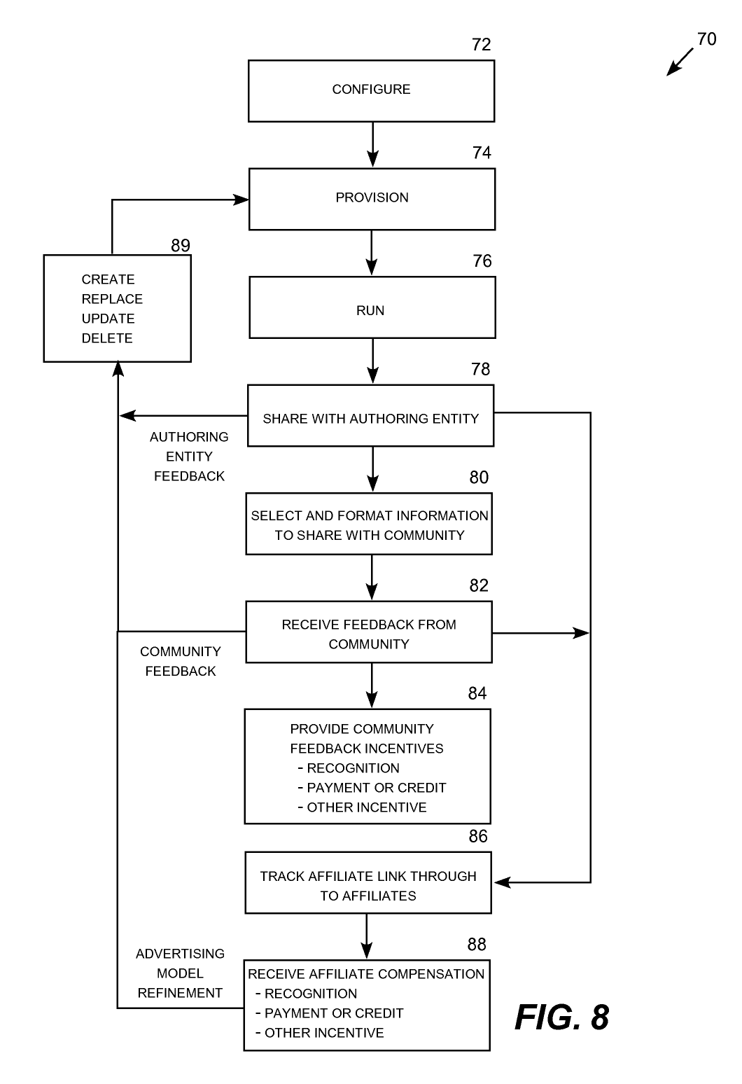

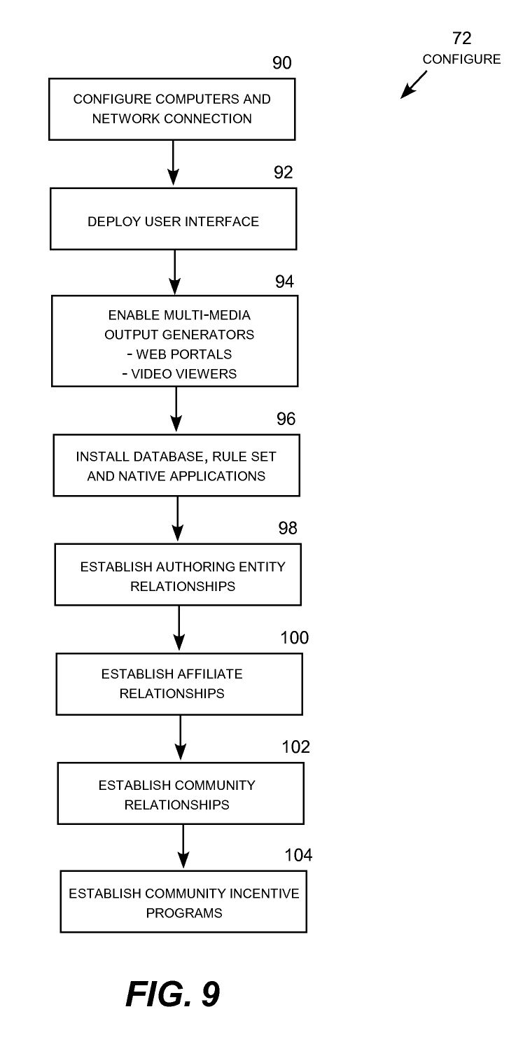

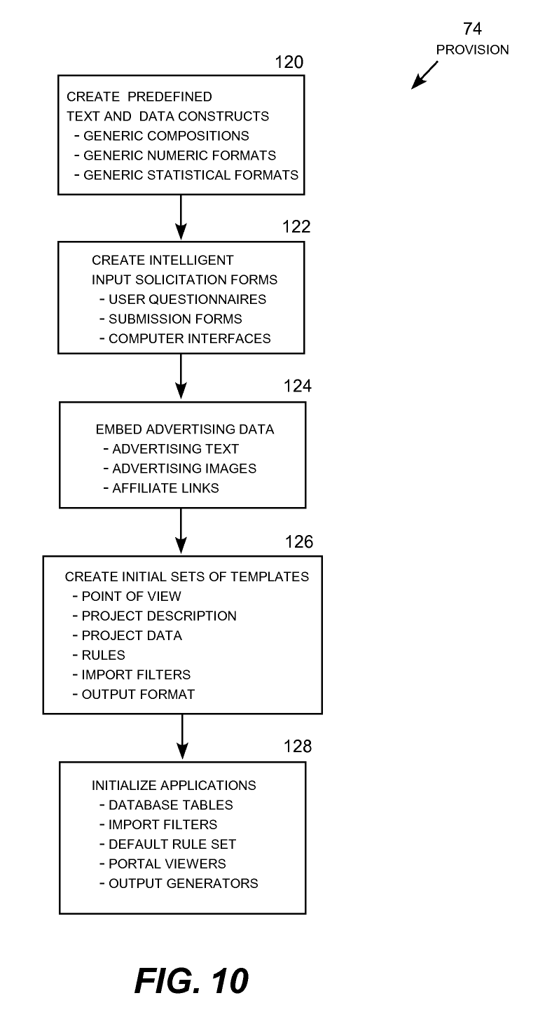

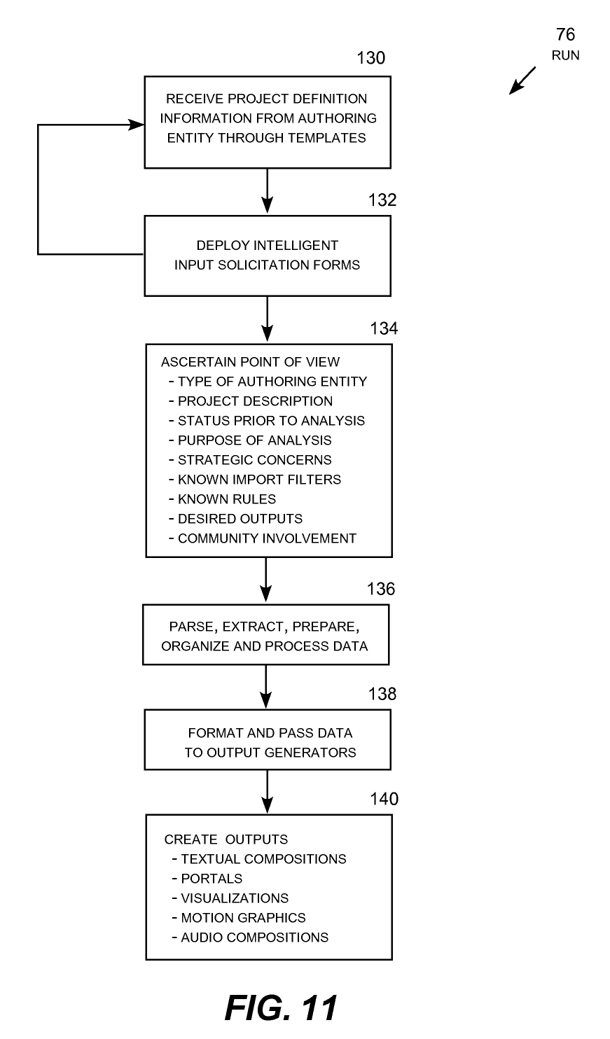

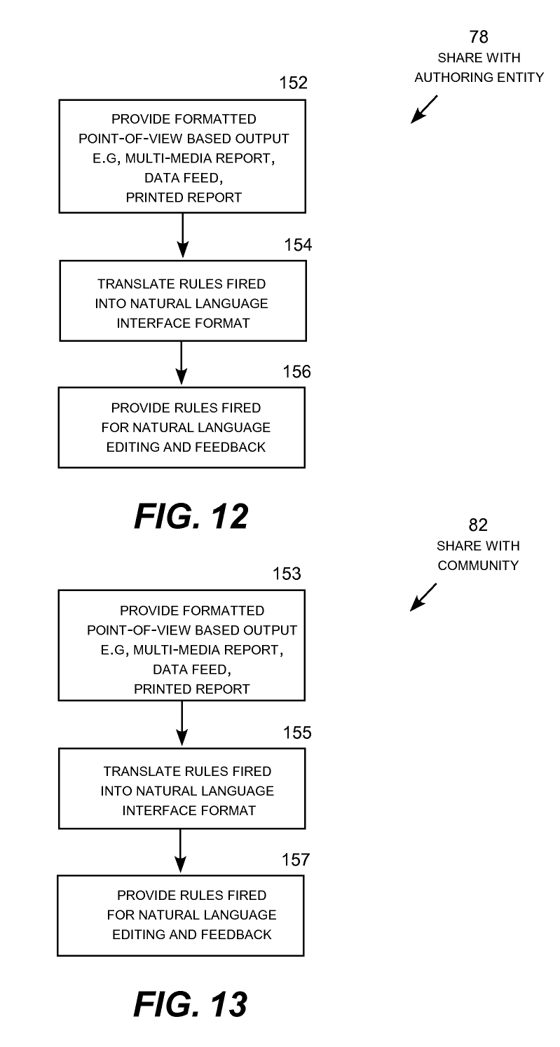

FIG. 8 is a logic flow diagram illustrating a business model 70 utilizing the TMAO system. As a first level of commercial implementation, the operator of the TMAO system may provide authoring entities with access to the system using a model of commerce based on a sale, license, pay-per-use, or subject to any other suitable form of compensation. An authorized entity typically receives an instance of the program or a password to access an application service implementing the TMAO system. In step 72, which is described further with reference to FIG. 9, the TMAO system is configured. Step 72 is followed by step 74, which is described further with reference to FIG. 10, in which the TMAO system is provisioned. Step 74 is followed by step 76, which is described further with reference to FIG. 11, in which the TMAO system is run. Step 76 is followed by step 78, which is described in greater detail with reference to FIG. 12, in which the TMAO output is displayed to the authoring entity. This includes display of the TMAO output, an example of which is shown in FIG. 3, and may also include a list of rules fired during the project run. If desired (e.g., as selected by the authoring entity), the fired rules are translated from a compiled format into (pseudo) natural language format (or retrieved from metadata containing the description) and displayed to the authoring entity for review and feedback, which may include creation of new rules, replacement of existing rules with new rule definitions, update of the rules, and deletion.

Step 78 may be followed by step 89, in which the authoring entity provides feedback to TMAO system, which may include rule modification as well as changes to the project data definition, the point of view, the desired outputs, or any other feature of the TMAO system. The process then loops from the feedback step 89 to the provision step 74, where the changes specified by the authoring entity are incorporated into the TMAO system. Step 74 is then followed by steps 76 and 78 for another iteration. The authoring entity may loop through as many refinement iterations as desired to develop the system and review the outputs produced along the way.

At the discretion of the authoring entity, step 78 may be followed by step 80, in which project information from the TMAO system may be selected, optionally formatted and shared with a community of one or more users, typically over a network connection (see FIG. 1). For example, the fired rules and selected outputs may be shared with the community for feedback to help in the development of the rule set. All or a portion of the project data (or a listing of the project data) and/or the TMAO output may also be shared with the community for feedback to help in the development of these aspects of the system.

Step 80 is followed by step 82, which is described in greater detail with reference to FIG. 13, in which members of the community provide feedback via, e.g., private or instant message, posted message, group discussion, moderated forum, vote, survey, poll or the like. Step 82 is followed by step 89, in which the community feedback is used to modify the TMAO system, typically after review and at the discretion of the authoring entity or the operator of the system. In some embodiments, review steps may be automated, in other embodiments, semi-automated and in still others, completely manual review is utilized. The process then loops from the feedback step 89 to the provision step 74, where the changes specified by the authoring entity are incorporated into the TMAO system. As a second level of commerce, step 82 may also be followed by step 84, the authoring entity or the operator of the TMAO system provides those community members providing feedback (or providing certain types of feedback, or providing feedback deemed to be useful) may receive some type of incentive, such as published recognition (e.g., reviewer reputation rating, which may include a review of reviewers function), credit (e.g., points for purchasing publications made available through the TMAO system), monetary payment, or any other suitable type of incentive. The incentive may be graduated to reflect the status (e.g., reputation rating) of the reviewer, the type of feedback provided, the usefulness of the feedback provided, or other factors. Note that as part of the community feedback process, the community members may be exposed to advertising information embedded in the TMAO output, click through to affiliate web sites, view promotional material, buy products or services, and so forth.

As a third level of commerce, steps 78 and 82 are followed by step 88, in which the TMAO system tracks advertising productivity for an associated compensation model. In particular, the TMAO system may monitor advertising exposures, click through to affiliate web sites, views of promotional material, purchases of products or services, and so forth. The authoring entity or the TMAO system operator may then receive compensation from affiliates receiving advertising benefits. Again, the compensation may include recognition, credit such as points in a point based reward system, monetary payment or any other suitable incentive agreed to by the parties involved. Step 88 is followed by step 89, in which the advertising model features of the TMAO system may be modified based on compensation received or other factors. For example, those affiliates providing compensation may be incremented in prominence or priority in the TMAO system to reflect the success of the advertising. Customer satisfaction with affiliate materials, products and services may also be monitored and used to refine the advertising model features of the TMAO system.

FIG. 9 is a logic flow diagram further explaining step 72 for configuring the TMAO system. In general, system configuration is performed by the operator (proprietor) of the TMAO system and involves acquiring and setting up the hardware, software, network connections, and relationships needed to implement the TMAO system. In step 90, the system operator installs the computers and network connections, which typically include at least a client system, a server system, and an Internet connection (see FIG. 1). Step 90 is followed by step 92, in which the system operator creates and deploys the user interface on the client system. Step 92 is followed by step 94, in which the system operator enables multi-media output generators, such as web portals and video viewers (see FIG. 3). Step 94 is followed by step 96, in which the system operator installs a database, rule set and other native applications used by the TMAO system (e.g., word processor, spreadsheet, slide presentation, statistical analyzer, network linking, HTML browser, XML authoring and/or editing, charting, graphing, etc.). Step 96 is followed by step 98, in which the system operator establishes authoring entity relationships, which typically includes a first level of commerce. Step 98 is followed by step 100, in which the system operator establishes affiliate relationships, which may include a second level of commerce. Step 100 is followed by step 102, in which the system operator establishes community relationships, which may include creating or joining a social or business-to-business online community. Step 102 is followed by step 104, in which the system operator establishes one or more community incentive programs, e.g., using points, credit, physical or virtual currency, which may include a third level of commerce.

Once the TMAO system has been configured it is ready for provisioning as shown in FIG. 10. Provisioning is typically performed by the operator of the TMAO system and involves initial data loading, programming and initialization of the system with system specific data and features. In step 120, the system operator creates the natural language or other data constructs used by the TMAO system to generate composite natural language composite text and data constructs. This typically includes systems of generic text compositions, generic data compositions, generic numerical display formats, generic statistical analysis formats, story structures (predefined and/or rule based), database formats, initial rule sets including rules of grammar, taxonomies, import filters, rules for statistical analysis, and so forth. Step 120 is followed by step 122, in which the system operator creates input solicitation forms preferably including intelligent input solicitation forms, such as systems of templates, structured and semi-structured input forms, intelligent questionnaires, and other suitable techniques for prompting detailed project definition information from the authoring entities.

Step 122 is followed by step 124, in which the system operator embeds advertising into the TMAO system, which typically includes advertising text to be embedded into TMAO output (in one embodiment), or to be displayed or exposed to an authoring entity during project creation or exploration (in another embodiment), such as composite text constructs making referrals and recommendations, advertising images such as affiliate logos, affiliate links, and so forth. Step 124 is followed by step 126, in which the system operator creates initial template systems for anticipated projects having expected points of view in initial areas of technology. This involves initial template systems for each anticipated project, for example each set of templates may include specially tailored point of view, project description, project data, rules, import filter, and output format templates. Step 126 is followed by step 128, in which the system operator initializes the native applications that will be used by the TMAO system, which may involve creating and loading default data into database tables, import filters, rule sets, portal viewers, and other output generators.

FIG. 11 is a logic flow diagram further explaining step 76 for running the TMAO system. Step 76 is typically implemented by the TMAO system with interaction from the authoring entity. In step 130, the TMAO system receives project definition information from the authoring entity using the template exposed through the client system. Step 130 is followed by step 132, in which the TMAO system deploys intelligent input solicitation forms, which typically involves iterative interaction with the authoring entity reflected by the loop between steps 130 and 132. Once the input solicitation process has been completed, which is typically indicated by a user input (e.g., continue), step 132 is followed by step 134, in which the TMAO system ascertains the Point of View for the project. This usually involves making an intelligent decision among predefined point of view types based on the input received from the authoring entity, which usually includes the type of authoring entity, the project description, the status of the project prior to the current iteration, the purpose of the analysis, the strategic concerns, known import filters, known rules, desired outputs, and the level of community involvement desired. Once the point of view has been established for the project, that decision drives the selection of story structures, taxonomies, import filters, story structure, generic text formats, text modifiers, numerical data formats, output formats, and any other features of the system tied to the point of view.

Based on the established point of view, step 134 is followed by step 136, in which the TMAO system parses, extracts, prepares, organizes and process the project data. This typically involves the use of one or morepoint of view-specific taxonomies and import filters used to parse, extract, organize, format and load extracted project data into the TMAO database and rule sets to process the data into creating the point of view-specific text and numerical data mining inserts. Step 136 is followed by step 138, in which the TMAO system formats the extracted data into the data formats required for the output generators and passes the properly formatted extracted data to the output generators in accordance with the point of view-specific story structure selected by the TMAO system for the project. Step 138 is followed by step 140, in which the TMAO system generates the outputs, which may include point of view-specific composite textual compositions, numerical data presentations, portals, visualizations, motion graphics, audio compositions, and other elements presented in accordance with the story structure selected by the TMAO system for the project (see FIG. 3 for a simple example).

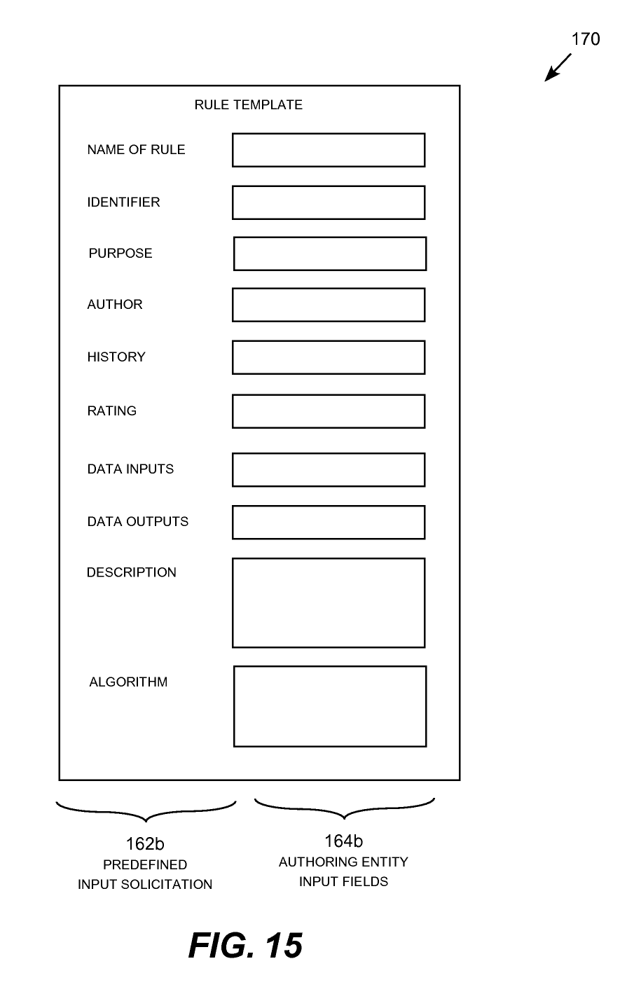

FIG. 12 is a logic flow diagram further explaining step 78 for obtaining user feedback in the text mining, analysis and output system. In step 152, the TMAO system provides the formatted output to the authorizing entity. Note that while the example output shown in FIG. 3 is a multi-media report, other types of output may be provided, such as data feeds, printed reports, audio presentation, music, medical data (e.g., spiral CT scan data), point cloud data (e.g., LiDAR) and any other type of output that a user integrates into the system. The operation of the rules is often key aspect of the project warranting examination and, in many cases, iterative feedback and modification. Step 152 is followed by step 154, in which the TMAO system translates the rules fired by the project into (pseudo) natural language format (or retrieves the description from metadata) and exposes the (pseudo) natural language and algorithm for the rule in an interface format, typically a rule template. An example rule template is shown in FIG. 15. Step 154 is followed by step 156, in which the TMAO system receives feedback on the rules and modifies the rule set. FIG. 13 illustrates the similar process utilized for community feedback. The only difference is that feedback received from the authoring entity is typically implemented in each instance, whereas community feedback is usually preceded by a decision by the authoring entity to refer selected portions of the project to the community and any incorporation of community feedback into model modification is likewise preceded by review, potential alteration and an approval decision by at least the authoring entity.

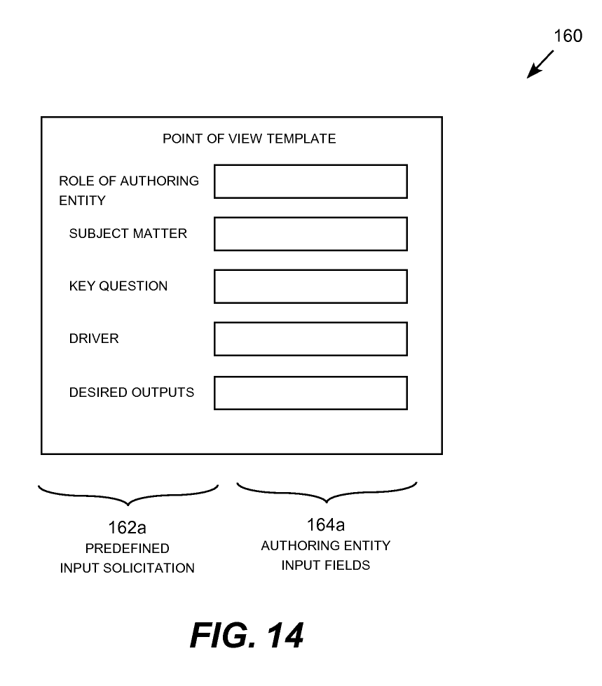

FIG. 14 is a simple example of an initial graphical user interface template 160 for point of view information. The template 160 is in structured or semi-structured format (or hybrid) with a number of predefined input solicitations 162a with corresponding entry fields 164a. The particular predefined input solicitations shown for this simplified example include “role of authoring entity”; “subject matter”; “key question”; “driver” and” desired outputs. For a structured form the entry field has a drop-down menu from which predefined entries may be selected, and for a semi-structured form the entry field accepts natural language text entered by the user. Typically an initial panel like this begins the definition of the point of view followed by an intelligent questionnaire selected from among a number of predefined intelligent questionnaires based on the input received via the template 160.

FIG. 15 is a graphical user interface template 170 for rule information. Certain items of information are useful for entities when selecting and providing feedback on rules. Like the point-of-view user template 160, the interface template 170 is in a structured or semi-structured format (or hybrid) with a number of predefined input solicitations 162b with corresponding entry fields 164b. In this panel, the input solicitations include the name of the rule, an identifier (which may be used by the system to fire the rule), the purpose of the rule (a brief description of the rule); the author of the rule (which may be instructive based on the reputation of the author), the history of the rule (which may be instructive based on the versioning, previous uses and experience with the rule); a rating (typically assigned by a relevant community using the rule); the data inputs required to run the rule, the data outputs produced by the rule, a natural language description of the rule, and the editable source code algorithm implemented by the rule. Some or all of this data is preferably incorporated into metadata stored with complied instances of the rule, and routinely updated, so that it can be loaded into the rule template whenever the rule is selected consideration. The rules template also provides a mechanism for gathering the desired metadata when a new rule is created, and updating the rule based on experience and feedback.

The present invention may consist of (but is not required to consist of) of adapting or reconfiguring presently existing systems. Alternatively, original equipment may be provided embodying the invention.

All of the methods described herein may include storing results of one or more steps of the method embodiments in a storage medium. The results may include any of the results described herein and may be stored in any manner known in the art. The storage medium may include any storage medium described herein or any other suitable storage medium known in the art. After the results have been stored, the results can be accessed in the storage medium and used by any of the method or system embodiments described herein, formatted for display to a user, used by another software module, method, or system, etc. Furthermore, the results may be stored “permanently,” “semi-permanently,” temporarily, or for some period of time. For example, the storage medium may be random access memory (RAM), and the results may not necessarily persist indefinitely in the storage medium.

It is further contemplated that each of the embodiments of the method described above may include any other step(s) of any other method(s) described herein. In addition, each of the embodiments of the method described above may be performed by any of the systems described herein.

Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile or non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected”, or “coupled”, to each other to achieve the desired functionality, and any two components capable of being so associated can also be viewed as being “couplable”, to each other to achieve the desired functionality. Specific examples of couplable include but are not limited to physically mateable and/or physically interacting components and/or wirelessly interactable and/or wirelessly interacting components and/or logically interacting and/or logically interactable components.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

Furthermore, it is to be understood that the invention is defined by the appended claims.

Although particular embodiments of this invention have been illustrated, it is apparent that various modifications and embodiments of the invention may be made by those skilled in the art without departing from the scope and spirit of the foregoing disclosure. Accordingly, the scope of the invention should be limited only by the claims appended hereto.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

The invention claimed is:

1. A text mining, analysis and output (TMAO) system, comprising:
a user interface configured to solicit input from an authoring entity defining a project including identification of project data;
a data processor configured to create or select a point of view for the project based on the input received from the authoring entity through the user interface;
the data processor further comprising a rule set configured to extract text and numerical data items from the project data based on the point of view created or selected for the project;
the data processor further configured to create a composite text composition based on the point of view created or selected for the project incorporating a data mining text insert based on one or more of the extracted text items;
the data processor further configured to create or select a story structure based on the point of view created or selected for the project providing a context for the composite text composition; and
a first output generator configured to display the composite text composition within the context of the story structure.

2. The TMAO system of claim 1, wherein:
the data processor is further configured to create a numerical composition based on the point of view created or selected for the project incorporating a data mining numerical insert based on one or more of the extracted numerical data items; and
a second output generator configured to display the numerical composition along with the composite text composition within the context of the story structure.

3. The TMAO system of claim 1, wherein the composite text composition further includes a grammatical modifier selected based on the point of view determined for the project.

4. The TMAO system of claim 1, wherein the user interface further includes a system of templates in structured or semi-structured format, or a hybrid structured and semi-structured format, configured for display and interaction with the authoring entity.

5. The TMAO system of claim 4, wherein the templates include a point of view template.

6. The TMAO system of claim 4, wherein the templates include a rule template that displays a natural language description of a rule and an editable algorithm implemented by the rule.

8. The TMAO system of claim 7, wherein the natural language description of a rule or the editable algorithm implemented by the rule is stored in metadata attached to a compiled version of the rule.

9. The TMAO system of claim 1, further comprising a user feedback processor configured to receive reviews of the output for the project and implement changes to the TMAO system based on the reviews, wherein the reviews may be received from the authoring entity or one or more members of a community.

10. The TMAO system of claim 1, further comprising a user feedback processor configured to receive at least one modification to a rule for the project and implement changes to the TMAO system based on the modification, wherein the modification may be received from the authoring entity or members of a community.

11. The TMAO system of claim 10, further comprising a community incentive program configured to provide incentives to members of the community to encourage useful feedback from the members of the community.

12. The TMAO system of claim 1, further comprising an advertising program configured to embed advertising information pertaining to an affiliate in the output and collect compensation from the affiliate based on advertising exposures to the affiliate's advertising information.

13. The TMAO system of claim 12, wherein:
the advertising exposures include one or more exposure types selected from first level view exposures on the TMAO system, second level view exposures on the TMAO system, click through exposures to an affiliate website, and buy exposures through the affiliate website, and
the compensation is based on quantities of exposure and their associates exposure types.

14. A business model implemented using a computer running a TMAO system, comprising:
a first level of commerce comprising selling, licensing or pay-per-use access to the TMAO system provided to authoring entities; and
a second level of commerce comprising incentives provided to community members to encourage feedback used to improve the TMAO system; and
a third level of commerce comprising compensation for advertising exposures provided or facilitated by the TMAO system.

15. The business model of claim 14, wherein:
the advertising exposures include one or more exposure types selected from first level view exposures on the TMAO system, second level view exposures on the TMAO system, click through exposures to an affiliate website, and buy exposures through the affiliate website, and
the compensation is based on quantities of exposure and their associates exposure types.

16. The business model of claim 14, wherein the first level of commerce comprises a server system providing the TMAO as an application service and a client system providing access to the TMAO to authorized authoring entities.

17. A method for providing text mining, analysis and output system, comprising the steps of:
displaying a user interface soliciting input from an authoring entity defining a project including identification of project data;
determining a point of view for the project based on the input received from the authoring entity through the user interface;
extracting text and numerical data items from the project data based on the point of view determined for the project;
creating a composite text composition based on the point of view determined for the project by incorporating a data mining text insert based on one or more of the extracted text items;
creating or selecting a story structure based on the point of view determined for the project providing a context for the composite text composition; and
displaying the composite text composition within the context of the story structure.

18. The method of claim 17, further comprising the steps of:
creating a numerical composition based on the point of view determined for the project incorporating a data mining numerical insert based on one or more of the extracted numerical data items; and
displaying the numerical composition along with the composite text composition within the context of the story structure.

19. The method of claim 18, further comprising the steps of:
receiving feedback on the output for the project from the authoring entity or members of a community, and
implementing changes to the TMAO system based on thefeedback.

20. The method of claim 18, further comprising the step of providing incentives to members of the community to encourage useful feedback from the members of the community.
